(19) United States
(12) Patent Application Publication
(10) Pub. No.: US 2002/0083161 A1
(43) Pub. Date: Jun. 27, 2002

(54) Network management system and a network management method

(76) Inventor: Naoto Miyauchi, Tokyo (JP)

Correspondence Address: BIRCH STEWART KOLASCH & BIRCH, PO BOX 747, FALLS CHURCH, VA, 22040-0747, US

(21) Appl. No.: 09/893,648

(22) Filed: Jun. 29, 2001

(30) Foreign Application Priority Data
Dec. 22, 2000 (JP) 2000-390579

(51) Int. Cl. G06F 15/173

(52) U.S. Cl. 709/223

(57) ABSTRACT

A network management system includes a plurality of communications apparatuses for performing communications through a network, an equipment management apparatus, connected to at least one of the communications apparatuses through the network, for monitoring and controlling the connected communications apparatuses, and a directory apparatus for managing connection relations between the plurality of communications apparatuses and the equipment management apparatus. The equipment management apparatus includes a directory client for transmitting an obtaining request for obtaining a connection relation and receiving the connection relation corresponding to the obtaining request. The directory apparatus includes a directory information base for storing the connection relations and a directory server for receiving the obtaining request from the directory client, searching the directory information base in order to detect the connection relation corresponding to the obtaining request, and transmitting the connection relation having been detected to the directory client.

### BACKGROUND OF THE INVENTION

1. Field of the Invention

The present invention relates to a network management system and method for monitoring and controlling a network apparatus.

2. Description of the Related Art

FIG. 25 shows an example of conventional network management model based on the network management model disclosed in FIG. 11/M. 3010 of “Principles for a Telecommunications Management Network” of CCITT (the International Telegraph and Telephone Consultative Committee (changed to ITU-T)) Recommendation M. 3010.

The network management model in FIG. 25 is composed of a network management apparatus 210 for managing the whole network, an equipment management apparatus 220 which is managed by the network management apparatus 210 and manages network equipment including communications apparatuses, and communications apparatuses 230a, 230b, and 230c.

The network management apparatus 210 is provided with a manager A 211 which is a program for managing the whole network. The equipment management apparatus 220 is provided with an agent B 221 which is a program for controlling (collecting, storing, updating, generating, deleting, etc.) management information, a management information base B 222 for storing the management information, and a manager B 223 which is a program for managing the network equipment including the communications apparatuses.

Each of the communications apparatuses (230a, 230b, and 230c) is provided with an agent C (231a, 231b, and 231c) which is a program for controlling management information, and a management information base C (232a, 232b, and 232c) for storing the management information.

The management information includes information for managing the whole network or the network equipment. The manager A 211 communicates with the agent B 221 by using a specific communications protocol, and accesses the management information base B 222 through the agent B 221. Thus, the manager A 211 collects, sets, generates and deletes the management information stored in the management information base B 222.

Now, operations will be explained. The agent C (231a, 231b, and 231c) of the communications apparatus (230a, 230b, and 230c) always stores and updates management information, such as communications traffic amount, in the management information base C (232a, 232b, and 232c). The agent B 221 of the equipment management apparatus 220 always stores and updates management information relating to the equipment management apparatus 220, in the management information base B 222.

First, an operator who uses the network management apparatus 210 requests the manager A 211 to collect management information of the communications apparatus (230a, 230b, and 230c). Receiving the request, the manager A 211 transmits a request for collecting management information of the communications apparatus (230a, 230b, and 230c), to the agent B 221 of the equipment management apparatus 220. The agent B 221 transmits the request for collecting management information of the communications apparatus (230a, 230b, and 230c), to the communications apparatus (230a, 230b, and 230c) via the manager B 223. The agent C (231a, 231b, and 231c) of the communications apparatus (230a, 230b, and 230c) analyzes the request for collecting management information of the communications apparatus received from manager B 223, searches the management information base C (232a, 232b, and 232c), and obtains management information corresponding to the request from the operator. Then, the obtained management information is transmitted to the manager B 223 as a response to the request for collecting management information.

The manager B 223 receives the response from the agent C (231a, 231b, and 231c), and transmits the response to the manager A 211 via the agent B 221. Receiving the response from the agent B 211, the manager A 211 transmits the response to the operator of the network management apparatus 210.

If the agent C (231a, 231b, and 231c) detects a fault of the communications apparatus (230a, 230b, and 230c), the agent C transmits a warning to the manager B 223. Receiving the warning from the agent C (231a, 231b, and 231c), the manager B 223 transmits the warning to the manager A 211 via the agent B 221. Then, the manager A 211 transmits the warning from the agent B 221 to the operator of the network management apparatus 210.

Similarly, an operator of the equipment management apparatus 220 requests the manager B 223 to collect management information of the communications apparatus (230a, 230b, and 230c). Then, the manager B 223 of the equipment management apparatus 220 collects management information of the communications apparatus (230a, 230b, and 230c) by using the agent C (231a, 231b, and 231c) in the same way as the above. In this way, the network management apparatus 210 and the equipment management apparatus 220 monitor and control the communications apparatus (230a, 230b, and 230c).

Thus, in the conventional network management system with reference to FIG. 25, one network management apparatus 210 is connected to one or more than one equipment management apparatus 220, and one equipment management apparatus 220 is connected to one or more than one communications apparatus (230a, 230b, and 230c). The conventional network management apparatus 210 manages the whole network depending upon such connections.

Generally, the number of communications apparatuses which one equipment management apparatus 220 can manage is previously defined to be x. Therefore, if the number of the communications apparatuses is increased (ex. x+1), it is necessary to increase the number of the equipment management apparatuses. Besides, the connection relation between the equipment management apparatus 220 and the communications apparatus (230a, 230b, and 230c) is not a dynamic relation, but a fixed one.

Accordingly the conventional network management apparatus has problems to be solved such as the below:

1: In the case of the number of the equipment management apparatuses being increased, it is necessary for the network management apparatus to form a new communications path to the increased equipment management apparatus. It is also necessary for the network management apparatus to be connected to the increased equipment management apparatus, with keeping the current connection relation to the communications apparatus and to the equipment management apparatus. Therefore, processing of the network management apparatus has become complicated.

2: In the case of the number of the equipment management apparatuses being increased, the following should be taken into account.

(1) Processing load of the equipment management apparatus

(2) Connection distance between the equipment management apparatus and the communications apparatus

(3) Re-examination and re-structure of the connection relation between the equipment management apparatus and the communications apparatus

Accordingly, the operation of connecting the equipment management apparatus and the communications apparatus has become complicated.

It is an object of the present invention to provide a network management system in which a communications apparatus optionally selected can be monitored and controlled by way of the network management apparatus connecting to an equipment management apparatus optionally selected.

### SUMMARY OF THE INVENTION

A network management system according to one aspect of the present invention comprises:

a plurality of communications apparatuses for performing communications through a network;

an equipment management apparatus, connected to at least one of the plurality of communications apparatuses through the network, for monitoring and controlling the at least one of the plurality of communications apparatuses; and

a directory apparatus for managing connection relations between the plurality of communications apparatuses and the equipment management apparatus,

wherein the equipment management apparatus includes a directory client for transmitting an obtaining request for obtaining a connection relation and receiving the connection relation corresponding to the obtaining request, and

the directory apparatus includes a directory information base for storing the connection relations and a directory server for receiving the obtaining request from the directory client, searching the directory information base in order to detect the connection relation corresponding to the obtaining request, and transmitting the connection relation having been detected to the directory client.

According to another aspect of the present invention, the network management system further comprises:

a network management apparatus for managing the plurality of communications apparatuses and the equipment management apparatus and transmitting the obtaining request,

wherein the directory client receives the obtaining request from the network management apparatus, transmits the obtaining request to the directory server, receives the connection relation corresponding to the obtaining request from the directory server, and transmits the connection relation having been received to the network management apparatus.

In the network management system according to another aspect of the present invention,

the equipment management apparatus includes a plurality of equipment management apparatuses,

the directory information base stores connection relations between the plurality of equipment management apparatuses and the plurality of communications apparatuses, and

the directory client included in one of the plurality of equipment management apparatuses transmits the obtaining request, to the directory server, for obtaining a connection relation between another of the plurality of equipment management apparatuses and at least one of the plurality of communications apparatuses connected to the another of the plurality of equipment management apparatuses, and receives the connection relation corresponding to the obtaining request from the directory server.

In the network management system according to another aspect of the present invention, the directory apparatus includes an input unit for receiving an input relating to the connection relation, and the directory server inputs the connection relation received through the input unit and stores the connection relation in the directory information base.

In the network management system according to another aspect of the present invention,

the equipment management apparatus further comprises a relation register unit for inquiring a connection relation between the equipment management apparatus and the plurality of communications apparatuses, and transmitting an inquired connection relation to the directory server, and

the directory server receives the inquired connection relation from the relation register unit and stores a received connection relation in the directory information base.

A directory apparatus according to one aspect of the present invention comprises:

a directory information base for storing connection relations defining communications paths between a plurality of communications apparatuses and a plurality of equipment management apparatuses which monitor and control the plurality of communications apparatuses; and

a directory server for receiving an obtaining request for obtaining a connection relation, searching the directory information base in order to detect the connection relation corresponding to a received obtaining request, and transmitting a detected connection relation.

According to one aspect of the present invention, a network management method of a network system composed of a plurality of communications apparatuses, and a plurality of equipment management apparatuses, connected to the plurality of communications apparatuses through a network, for monitoring and controlling the plurality of communications apparatuses, the network management method comprises:

storing connection relations for defining communications paths connecting the plurality of communications apparatuses and the plurality of equipment management apparatuses in a directory information base;

receiving an obtaining request for obtaining a connection relation;

detecting the connection relation corresponding to a received obtaining request by way of searching the directory information base; and

transmitting a detected connection relation.

The above-mentioned and other objects, features, and advantages of the present invention will be made more apparent by reference to the following detailed description when taken in conjunction with the accompanying drawings.

### BRIEF DESCRIPTION OF THE DRAWINGS

In the drawings,

FIG. 1 shows an example of configuration according to Embodiment 1 of the present invention;

FIG. 2 shows an example of connection relation between the equipment management apparatus and the communications apparatus stored in the directory information base;

FIG. 3 shows an example of information history stored in the management information history base of the equipment management apparatus;

FIG. 4 shows an example of operation sequence according to Embodiment 1;

FIG. 5 shows an example of configuration according to Embodiment 2 of the present invention;

FIG. 6 shows an example of operation sequence according to Embodiment 2;

FIG. 7 shows an example of configuration according to Embodiment 3 of the present invention;

FIG. 8 shows an example of information stored in the number control unit;

FIG. 9 shows an example of configuration according to Embodiment 4 of the present invention;

FIG. 10 shows an example of information stored in the directory information base;

FIG. 11 shows an example of configuration according to Embodiment 5 of the present invention;

FIG. 12 shows an example of operation sequence according to Embodiment 5;

FIG. 13 shows an example of configuration according to Embodiment 6 of the present invention;

FIG. 14 shows an example of operation sequence according to Embodiment 6;

FIG. 15 shows an example of information stored in the directory information base according to Embodiment 6;

FIG. 16 shows an example of configuration according to Embodiment 7 of the present invention;

FIG. 17 shows an example of operation sequence according to Embodiment 7;

FIG. 18 shows an example of operation sequence according to Embodiment 7;

FIG. 19 shows an example of configuration according to Embodiment 8 of the present invention;

FIG. 20 shows an example of operation sequence according to Embodiment 8;

FIG. 21 shows an example of operation sequence according to Embodiment 8;

FIG. 22 shows an example of configuration according to Embodiment 9 of the present invention;

FIG. 23 shows an example of operation sequence according to Embodiment 9;

FIG. 24 shows an example of operation sequence according to Embodiment 9; and

FIG. 25 shows an example of a conventional network management model.

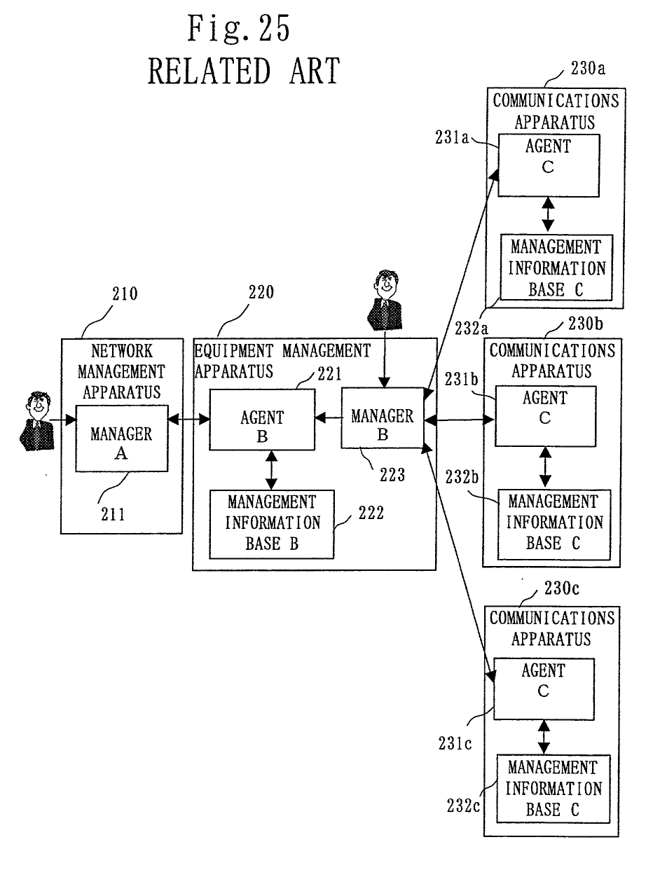

### DETAILED DESCRIPTION OF PREFERRED EMBODIMENTS

Embodiment 1

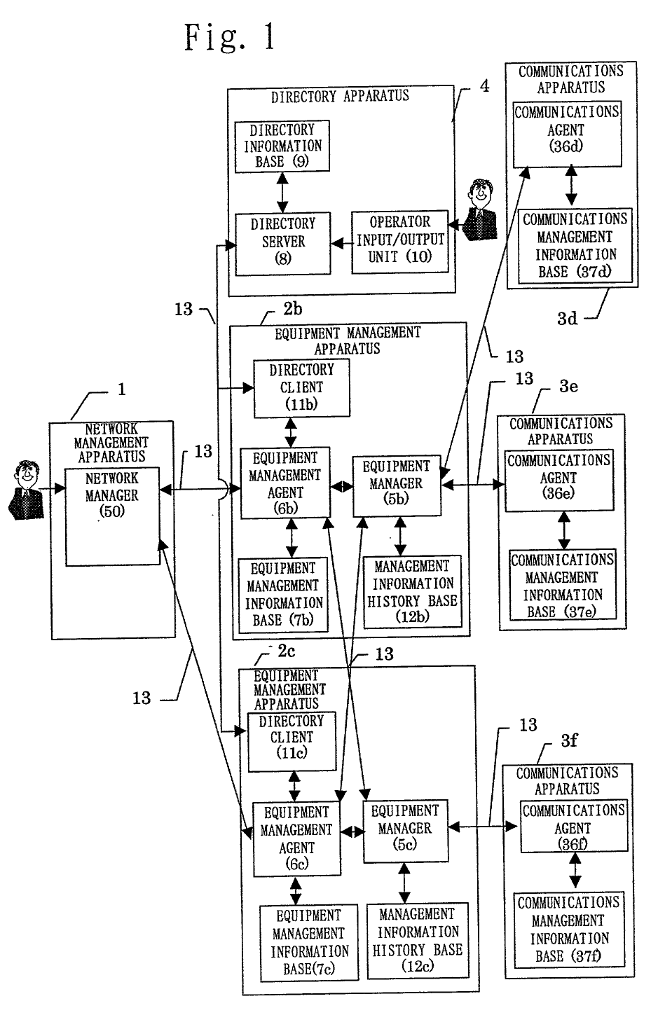

FIG. 1 shows an example of configuration according to Embodiment 1. In FIG. 1, a network management apparatus 1 connected to an equipment management apparatus 2 (2b, or 2c) is a computer for monitoring and controlling the whole network. The equipment management apparatus 2 connected between the network management apparatus 1 and a communications apparatus 3 (3d, 3e, or 3f) is a computer for monitoring and controlling the communications apparatus 3. The communications apparatus 3 which performs communications is monitored and controlled by the equipment management apparatus 2.

A directory apparatus 4 is a computer for storing a connection relation between the equipment management apparatus 2 and the communications apparatus 3. The directory apparatus 4 manages the connection relation between the equipment management apparatus 2 and the communications apparatus 3. The connection relation is information (connection relation information) relates to a connection between the equipment management apparatus 2 and the communications apparatus 3.

A network manager 50 manages management information relating to a configuration and performance of the whole network, a fault generated in the network and so forth. In this case, the whole network indicates the connection states of a plurality of communications apparatuses 3, and communication paths to the plurality of communications apparatuses 3.

An equipment managers 5 (5b or 5c) manages management information relating to an internal configuration and performance of communications apparatus 3 connected to the equipment manager, a fault generated in the communications apparatus 3 and so forth.

An equipment management agent 6 (6b or 6c) transmits the management information received from the connected communications apparatus 3 and management information of corresponding equipment management apparatus 2b or 2c, to the network management apparatus 1.

A communications agent 36 (36d, 36e, or 36f) transmits management information (ex. amount of communication, the number of input/output interfaces) of connected communications apparatus 3 to the corresponding equipment management apparatus 2.

An equipment management information base 7 (7b, or 7c) and a communications management information base 37 (37d, 37e, or 37f) are data bases for storing management information.

A directory server 8, which is a program for processing an inquiry or an update request from a directory client 11 (11b or 11c), accesses a directory information base 9.

The directory information base 9 is a database for storing a connection relation between the equipment management apparatus 2 and the communications apparatus 3. The connection relation includes information for connecting the equipment management apparatus 2 with the communications apparatus 3, and information relating to the connection.

An operator input/output unit (input unit) 10 provides an operator interface used for accessing the directory information base 9 by the operator. The directory client 11 is a program for accessing to the directory server 8.

A management information history base 12 (12b, or 12c) stores information histories of the equipment management apparatus 2 inputting and outputting from/to the network management apparatus 1 or the communications apparatus 3. By referring to the history stored in the management information history base 12, the equipment management apparatus 2 can grasp requests just being processed.

A transmission line 13 is a communications medium for connecting the network management apparatus 1, the equipment management apparatus 2, the communications apparatus 3, and the directory apparatus 4.

The management information includes data relating to the connection state between the equipment management apparatus 2 and a plurality of communications apparatuses 3, the configuration of transmission line connecting the equipment management apparatus 2 with a plurality of communications apparatuses 3, and configuration information, performance information, and fault information of the communications apparatus 3.

Management information managed by the equipment manager 5 of the equipment management apparatus 2 includes configuration information, fault information, and performance information corresponding to the type of the communications apparatus 3.

For instance, the number and the type of board, the type of CPU (Central Processing Unit), and the memory size loaded on the switching system by M. Company, a calling number of telephone to which the switching system is connected, and the type or the capacity of telephone line are included in the management information.

Management information managed by the network manager 50 of the network management apparatus 1 differs from the management information by the equipment manager 5 in the respect that management information corresponding to the type of the communications apparatus 3 is not included in the information managed by the network manager 50.

In the example of FIG. 1, the network manager 50 manages the connection relation between the equipment management apparatus 2b and the communications apparatus 3d or 3e, and the connection relation between the equipment management apparatus 2c and the communications apparatus 3f. The equipment manager 5 manages management information of the communications apparatus 3 connected to the equipment management apparatus 2 where the equipment manager 5 itself is included. The different respect between the network manager 50 and the equipment management apparatus 2 is that one equipment management apparatus 2 basically does not manage management information of the communications apparatus 3 connected to other equipment management apparatus 2.

In the following explanation, management information will be described without being distinguished with respect to the difference stated above.

Besides, each of a plurality of equipment management apparatuses 2 will be represented as the equipment management apparatus 2b or the equipment management apparatus 2c as shown in FIG. 1. In the case of being represented as the equipment management apparatus 2, it indicates all the plurality of equipment management apparatuses (2b, 2c, . . . ) or one of the plurality of equipment management apparatuses (2b, 2c, . . . ). The similar word definition (such as all or each one) can be applied to the case of the equipment manager 5, the equipment management agent 6, the equipment management information base 7, the communications apparatus 3, the communications agent 36, and a communications management information base 37.

Operations will now be explained under the conditions that the configuration of FIG. 1 is used. The network management apparatus 1 is connected with the equipment management apparatus 2b and the equipment management apparatus 2c. The equipment management apparatus 2b is connected with the communications apparatuses 3d and 3e, and monitors and manages the communications apparatuses 3d and 3e. The equipment management apparatus 2c is connected with the communications apparatus 3f, and monitors and manages the communications apparatus 3f.

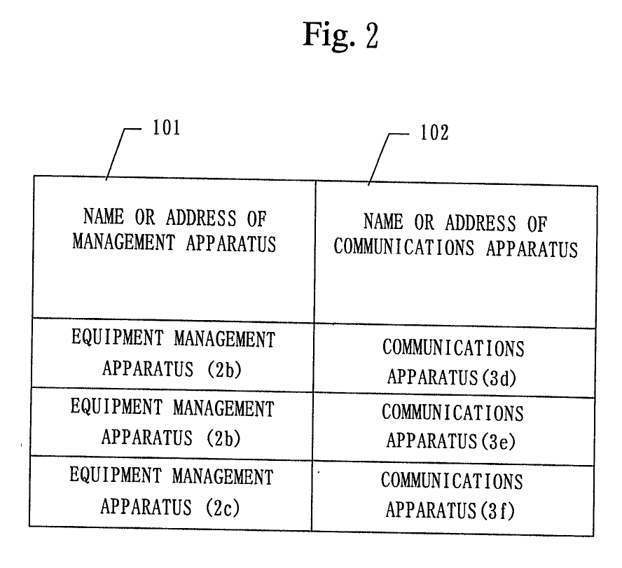

The operator of the directory apparatus 4 inputs the connection relation, as shown in FIG. 2, between the equipment management apparatus 2 and the communications apparatus 3 through the operator input/output unit 10 in advance. The directory server 8 stores the input connection relation between the equipment management apparatus 2 and the communications apparatus 3 in the directory information base 9.

In FIG. 2, “name or address of management apparatus” 101 indicates a name or address of the equipment management apparatus 2, and “name or address of communications apparatus” 102 indicates a name or address of the communications apparatus 3. Namely, as shown in FIG. 2, the connection relation stored in the directory information base 9 indicates a corresponding relation between the equipment management apparatus 2 and the communications apparatus 3 which is monitored and managed by the equipment management apparatus 2.

In this specification, for the purpose of making the corresponding relation with respect to FIG. 1 clear, names of the configuration elements, not addresses of them, are used in the columns of “name or address of management apparatus” or “name or address of communications apparatus”.

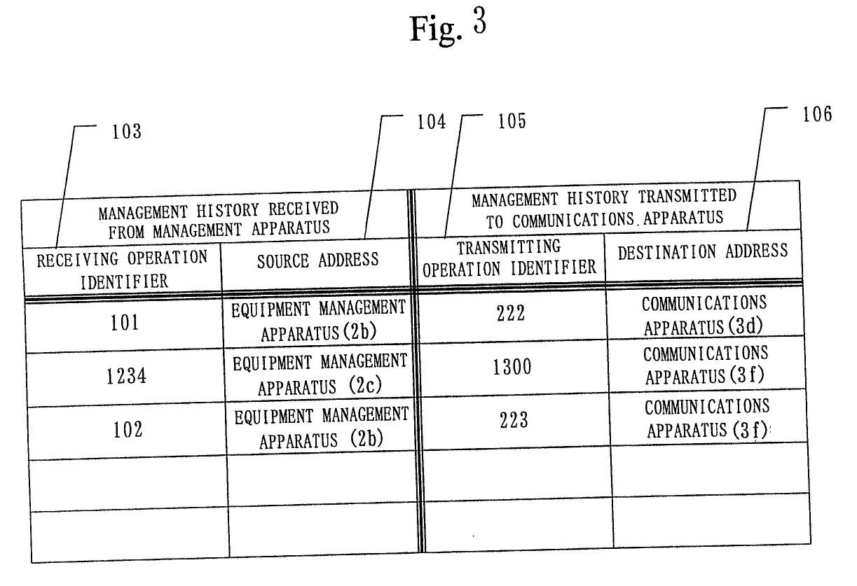

FIG. 3 shows an example of information stored in the management information history base 12c of the equipment management apparatus 2c according to Embodiment 1. In FIG. 3, “receiving operation identifier 103” indicates an operation identifier applied to management operation received from another equipment management apparatus 2, and “source address 104” indicates an address of the equipment management apparatus 2. “Transmitting operation identifier 105” indicates an operation identifier applied to management operation transmitted to the communications apparatus 3, and “destination address 106” indicates an address of the communications apparatus 3. By referring to the information stored in the management information history base, the equipment management apparatus 2 can identify the destination of mapping of the management operation received from another equipment management apparatus 2. Namely, the equipment management apparatus 2 can identify to which communications apparatus 3 the mapping of the management operation received from another equipment management apparatus 2 has been performed.

The “management operation” is a communications message to be transmitted from the network management apparatus 1 to the equipment management apparatus 2. As an example, a communications message requesting to obtain management information or to set management information can be the above message. A communications message transmitted from the equipment management apparatus 2 to the communications apparatus 3 can also be the “management operation”. In the following explanation, the communications message to be transmitted from the network management apparatus 1 to the equipment management apparatus 2 is sometimes called a management operation A and the communications message to be transmitted from the equipment management apparatus 2 to the communications apparatus 3 is sometimes called a management operation B.

The “mapping” indicates a processing which relates the management operation A transmitted from the network management apparatus 1 to the equipment management apparatus 2 with the management operation B transmitted from the equipment management apparatus 2 to the communications apparatus 3. The management information history base 12 executes the processing of mapping.

For example, if the network management apparatus 1 needs to collect management information of the communications apparatus 3d, the following procedure will be performed.

1. The network management apparatus 1 transmits the management operation A to the equipment management apparatus 2b.

2. The equipment management apparatus 2b transmits the management operation B to the communications apparatus 3d.

3. The communications apparatus 3d transmits a response to the management operation B, to the equipment management apparatus 2b.

4. The equipment management apparatus 2b transmits a response to the management operation A, to the network management apparatus 1.

During the above procedure, the equipment management apparatus 2b needs to perform mapping (making relation) of the management operation A and the management operation B, because it is impossible to transmit a response with making relations between a plurality of management operations A and a plurality of management operations B. Therefore, the mapping is executed by using the management information history base 12.

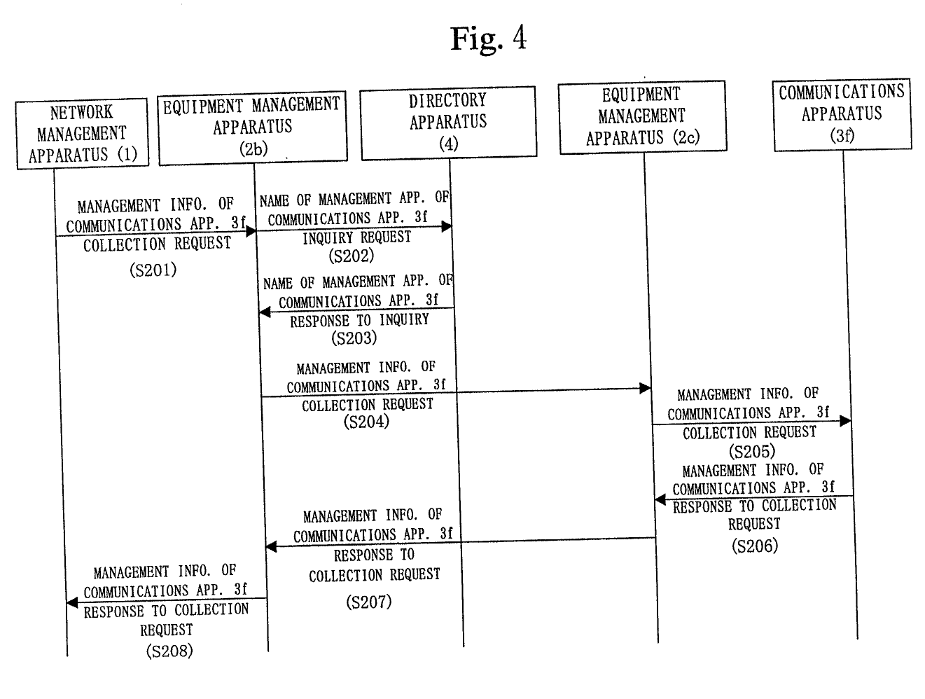

FIG. 4 shows an example of operation sequence according to Embodiment 1. The operation of the network management apparatus 1 monitoring and controlling the communications apparatus 3f by using the equipment management apparatus 2b will be explained with reference to FIG. 4.

At step 201, the manager 50 of the network management apparatus 1 transmits a request for collecting management information of the communications apparatus 3f, to the equipment management agent 6b of the equipment management apparatus 2b. The request for collecting management information is a communications message including an apparatus identifier for identifying an apparatus being the object of collecting management information, and an operation identifier for identifying the request for collecting management information. The request for collecting management information is generated in the apparatus which outputs the request.

The equipment management agent 6b of the equipment management apparatus 2b inquires of the directory client 11b about a name or address of management apparatus which monitors and controls the communications apparatus 3f. The directory client 11b inquires of the directory server 8 of the directory apparatus 4 about the name or address of the communications apparatus 3f at step 202.

The directory server 8 searches the directory information base 9 for obtaining the name or address of the management apparatus of the communications apparatus 3f. In this case, the directory server 8 obtains the name of the equipment management apparatus 2c. Then, the directory server 8 transmits the name of the management apparatus of the communications apparatus 3f to the directory client 11b of the equipment management apparatus 2b. The directory client 11b transmits the name of the management apparatus of the communications apparatus 3f to the equipment management agent 6b at step 203.

The equipment management agent 6b of the equipment management apparatus 2b transmits the request for collecting management information of the communications apparatus 3f, to the equipment manager 5c of the equipment management apparatus 2c at step 204.

The equipment manager 5c transmits the request for collecting management information to the communications apparatus 3f, and simultaneously, as shown in FIG. 3, stores the address of the equipment management agent 6b, the operation identifier (102, in this case) applied to the management information collection request, the address of the communications apparatus 3f, and the operation identifier (223, in this case) included in the management information collection request, in the management information history base 12c at step 205.

Receiving the request for collecting management information from the equipment manager 5c, the communications apparatus 3f generates a response to the request for collecting management information and transmits the generated response to the equipment manager 5c. The response to the request for collecting management information is a communications message including the management information corresponding to the request and the operation identifier included in the request. This response to the request for collecting management information is generated in the apparatus which outputs the response. The equipment manager 5c of the equipment management apparatus 2c receives the response to the request for collecting management information from the communications apparatus 3f at step 206.

The equipment manager 5c searches the management information history base 12c based on the operation identifier (223, in this case) included in the received response to the request for collecting management information, and obtains the address and the operation identifier (102, in this case) of the equipment management agent 6b. Then, the equipment manager 5c outputs the response to the request for collecting management information (the operation identifier is 102, in this case) to the equipment management agent 6b of the equipment management apparatus 2b at step 207.

The equipment management agent 6b transmits the response to the network manager 50 of the network management apparatus 1 at step 208.

The operation of the network management apparatus 1 transmitting the request for collecting management information to the equipment management apparatus 2b has been explained with reference to the example shown in FIG. 4. The same operation is performed in the case of the network management apparatus 1 transmitting the request to the equipment management apparatus 2c or to other equipment management apparatus 2.

Since the directory client 11 is located in the equipment management apparatus 2 and the directory apparatus 4 is provided in this network system, it is possible for the network management apparatus 1 to monitor and control any communications apparatus 3 optionally selected just by way of being connected with an optional equipment management apparatus 2.

As stated above, the network management system according to the present Embodiment has the following features. The network management system is composed of the equipment management apparatus 2 for monitoring and controlling a plurality of communications apparatuses 3 which configures the communications network, and of the network management apparatus 1 for managing the equipment management apparatus 2. This network management system is provided with the directory apparatus 4 for storing the connection relation between the equipment management apparatus 2 and the communications apparatus 3, the directory information base 9 for storing the connection relation between the equipment management apparatus and the communications apparatus in the directory apparatus, and the directory server 8 for accessing to the directory information base. The directory client 11 and the management information history base 12 are included in the equipment management apparatus 2.

According to one aspect of the network management system and the network management method of the present Embodiment, as the connection relation between the equipment management apparatus and the communications apparatus is managed independently of the equipment management apparatus itself, the load of the equipment management apparatus can be lessened.

According to another aspect of the network management system and the network management method of the present Embodiment, the network management apparatus can obtain management information of the communications apparatuses without taking the connection relation between the equipment management apparatus and the communications apparatus into consideration.

According to another aspect of the network management system and the network management method of the present Embodiment, it is possible to centralize the management of connection relations between a plurality of equipment management apparatuses and a plurality of communications apparatuses by using the directory apparatus.

According to another aspect of the network management system and the network management method of the present Embodiment, as the input unit is provided, it is possible for the operator to input a connection relation through the input unit.

Embodiment 2

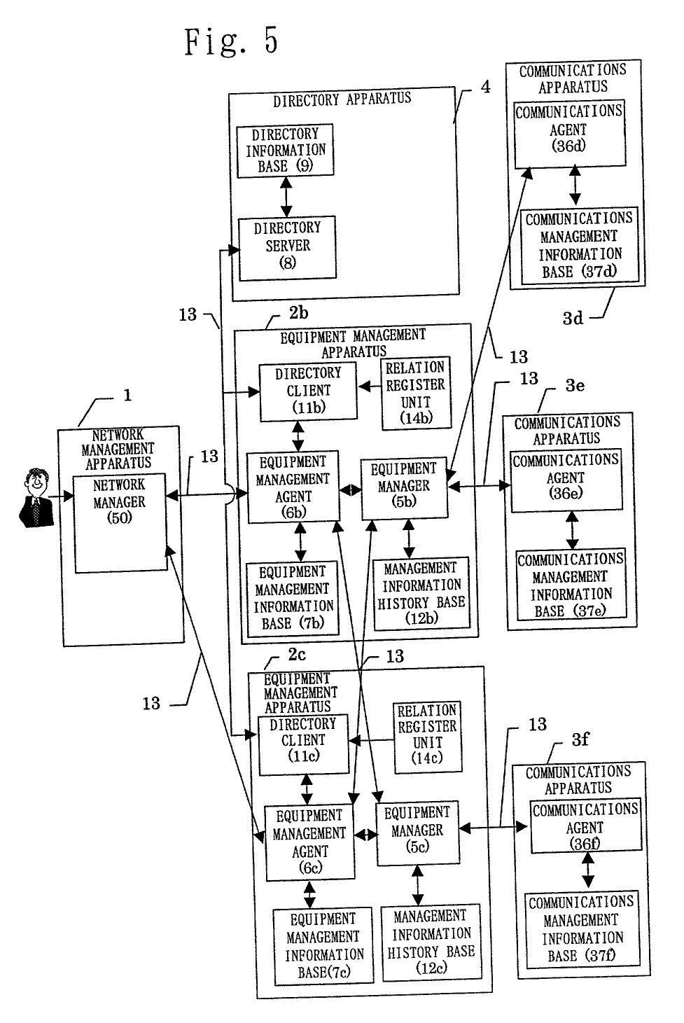

FIG. 5 shows an example of configuration according to Embodiment 2 of the present invention. In FIG. 5, configuration elements represented by the same references used in FIG. 1 indicate the same elements as those of Embodiment 1. A relation register unit 14 conveys the relation between the equipment management apparatus 2 and the communications apparatus 3 to the directory client 11. A relation register unit 14b is provided in the equipment management apparatus 2b and a relation register unit 14c is provided in the equipment management apparatus 2c.

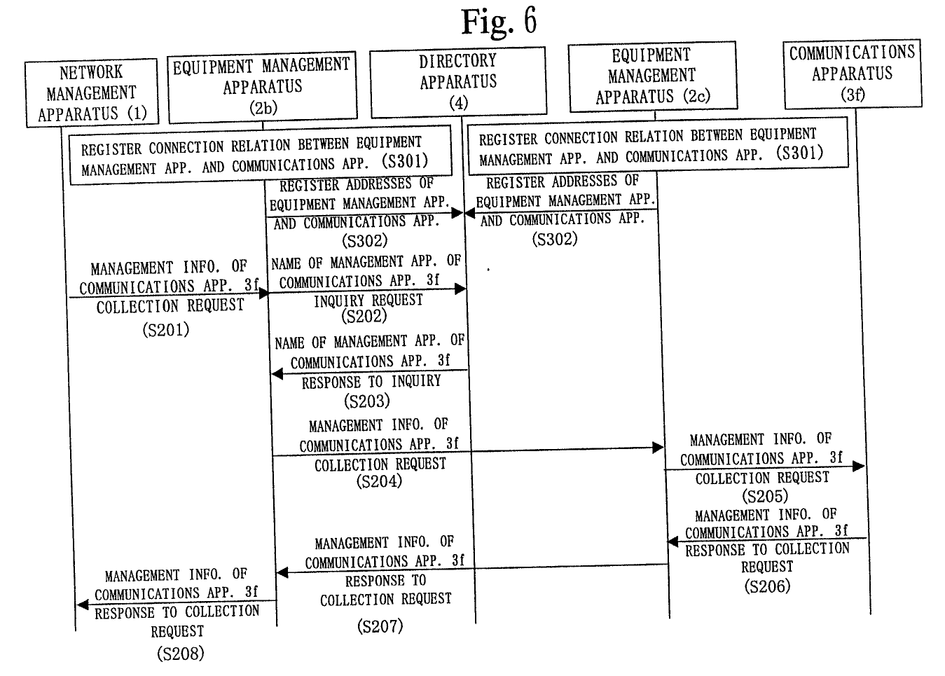

Now, operations will be explained. FIG. 6 shows an example of operation sequence according to Embodiment 2. The equipment management apparatus 2b and the equipment management apparatus 2c are connected to the directory apparatus 4.

In the equipment management apparatus 2, after the connection between the equipment manager 5 and the communications apparatus 3 has been finished, the equipment manager 5 registers the connection relation between the equipment management apparatus 2 and the communications apparatus 3 in the relation register unit 14 at step 301. Next, the relation register unit 14 transmits a list of names or addresses of the communications apparatus 3 monitored and controlled by the equipment management apparatus 2, to directory server 8 of the directory apparatus 4 via the directory client 11. The directory server 8 receives the list and stores it in the directory information base 9 at step 302. Consequently, the corresponding relation between the name or address of the equipment management apparatus and the name or address of the communications apparatus is stored in the directory information base 9 of the directory apparatus 4.

In the case of FIG. 5, the registering is executed in the equipment management apparatus 2b and the equipment management apparatus 2c as follows:

In the equipment management apparatus 2b, after the connections between the equipment manager 5b and the communications apparatus 3d and between the equipment manager 5b and the communications apparatus 3e have been executed, the equipment manager 5b registers the connection relations between the equipment management apparatus 2b and the communications apparatus 3d and between the equipment management apparatus 2b the communications apparatus 3e in the relation register unit 14b at step 301. Next, the relation register unit 14b transmits lists of names or addresses of the communications apparatus 3d and the communications apparatus 3e monitored and controlled by the equipment management apparatus 2b, to the directory server 8 of the directory apparatus 4 via the directory client 11b. The directory server 8 receives the list and stores it in the directory information base 9 at step 302.

Similar to the above case, in the equipment management apparatus 2c, after the connection between the equipment manager 5c and the communications apparatus 3f has been executed, the equipment manager 5c registers the connection relation between the equipment management apparatus 2c and the communications apparatus 3f in the relation register unit 14c at step 301. Next, the relation register unit 14c transmits a list of names or addresses of the communications apparatus 3f monitored and controlled by the equipment management apparatus 2c, to the directory server 8 of the directory apparatus 4 via the directory client 11c. The directory server 8 receives the list and stores it in the directory information base 9 at step 302.

Operations performed after this process (that is the monitoring and controlling operations for the optional communications apparatus 3 optionally selected) are the same as those after the step 201 in Embodiment 1.

Since the relation register unit 14 is provided in the equipment management apparatus 2, the connection relation between the equipment management apparatus 2 and the communications apparatus 3 can be registered in directory apparatus 4 without depending upon the operator. The network management apparatus 1 can monitor and control a communications apparatus 3 optionally selected only by being connected to one equipment management apparatus 2 optionally selected.

In addition to the features of the network management system according to Embodiment 1, the network management system of Embodiment 2 has a feature that the relation register unit 14 for transmitting the connection relation between the equipment management apparatus 2 and the communications apparatus 3 to the directory client 11 is provided in the equipment management apparatus 2.

According to one aspect of the network management system and the network management method of the present Embodiment, as the relation register unit is provided, it is possible to automatically inquire connection relations and to store the inquired result in the directory information base. Therefore, registering and updating connection relations can be effectively performed.

Embodiment 3

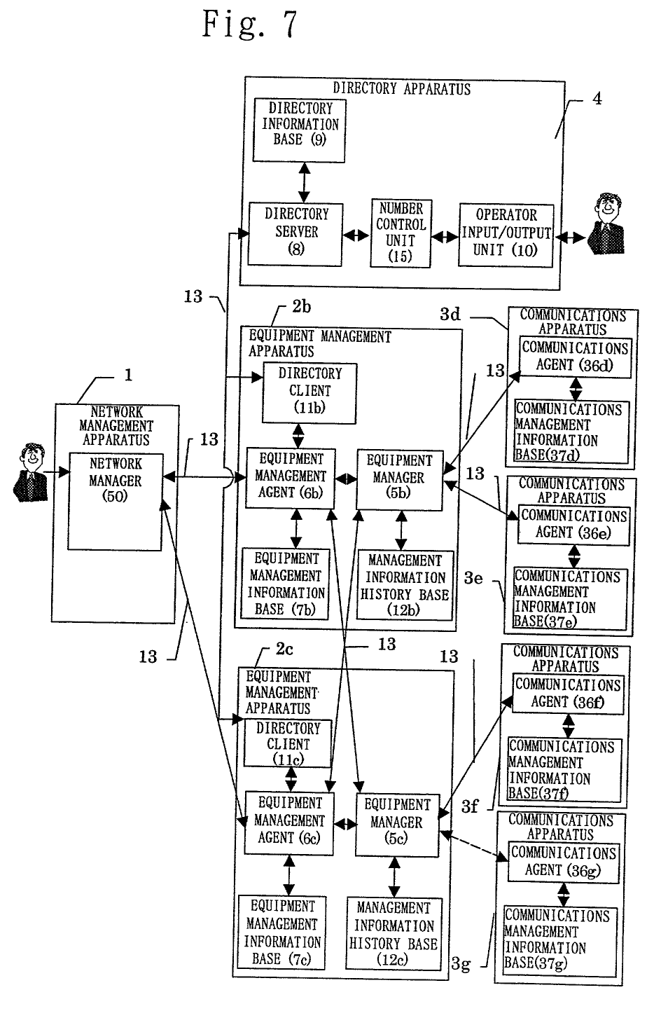

FIG. 7 shows an example of configuration according to Embodiment 3 of the present invention. In FIG. 7, configuration elements represented by the same references used in FIG. 1 indicate the same elements as those of Embodiment 1.

A number control unit 15 stores the maximum number of communications apparatuses 3 which can be connected with the equipment management apparatus 2 and a current number of the communications apparatuses 3 which are currently connected with the equipment management apparatus 2, and controls the number of communications apparatuses 3 connected with the equipment management apparatus 2. The number control unit 15 includes a communications apparatus information table (not shown in FIG. 7) for storing the maximum number of communications apparatuses 3 which can be connected with the equipment management apparatus 2 and the current number of the communications apparatuses 3 which are currently connected with the equipment management apparatus 2. In the following explanation, the operation of registering information in the number control unit 15 practically indicates the operation of registering it in the communications apparatus information table.

Operations will now be explained. The operator of the directory apparatus 4 inputs the name of equipment management apparatus 2 and the number of communications apparatuses which the equipment management apparatus 2 can manage, through the operator input/output unit 10. The operator input/output unit 10 registers the input name of equipment management apparatus 2 and the input number of the communications apparatuses which can be managed by the equipment management apparatus 2, into the number control unit 15. By way of this operation, the number of communications apparatuses 3 which the equipment management apparatus 2 can manage is stored in the number control unit 15 of the directory apparatus 4 at step 401. The operations according to the present Embodiment (step 401 through step 404) are not shown in the drawings.

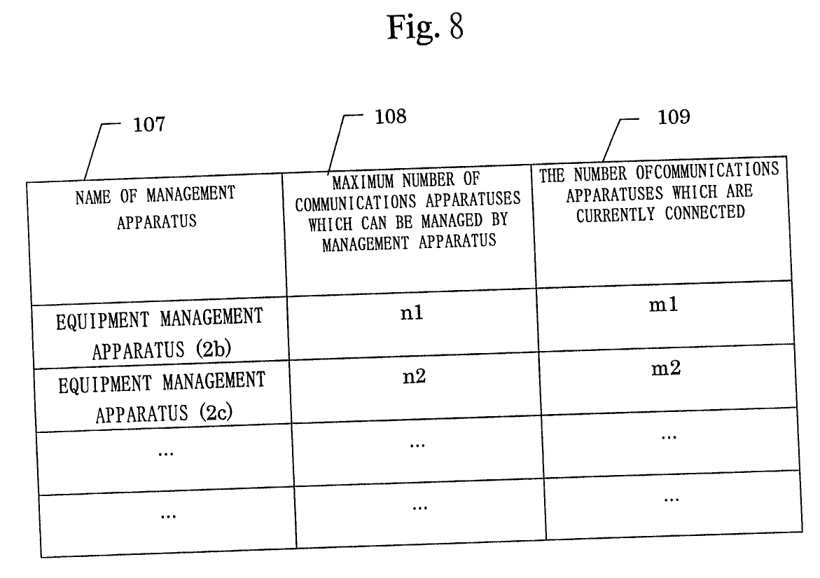

FIG. 8 illustrates an example of information stored in the number control unit 15, where the name 107 of management apparatus, the maximum number 108 of the communications apparatuses 3 which the management apparatus can manage, and the number 109 of communications apparatuses 3 which are currently connected with the management apparatus are shown. In one case of FIG. 8, the maximum number of the communications apparatuses which the equipment management apparatus 2b can manage is n1, and the number of communications apparatuses which are currently connected with the equipment management apparatus 2b is m1. In another case, the maximum number of communications apparatuses which the equipment management apparatus 2c can manage is n2, and the number of communications apparatuses which are currently connected with the equipment management apparatus 2c is m2.

When the operator of the directory apparatus 4 performs registering m communications apparatuses 3 through the operator input/output unit 10, the number control unit 15 assigns m ×n1/(n1+n2+. . . ) communications apparatuses 3 to the equipment management apparatus 2b, and the number control unit 15 also assigns m×n2/(n1+n2+. . . ) communications apparatuses 3 to the equipment management apparatus 2c. In these calculations, rounding off is performed, at the first decimal place, to a whole number. The number control unit 15 stores the assigned number in “the number of communications apparatuses currently connected” (109 in FIG. 8) of the number control unit 15. If the same number of communications apparatuses 3 are assigned to a plurality of equipment management apparatuses 2, relating the equipment management apparatus 2 to the communications apparatus 3 is performed in order, from the equipment management apparatus 2 in the upper line of information in the number control unit 15 to the one in the lower line at step 402. The relating (that is assigning) means to define the connection relation between the equipment management apparatus 2 and the communications apparatus 3. Namely, if one (or plural) communications apparatus 3 is assigned to a plurality of equipment management apparatuses 2, the equipment management apparatus 2 from the one in the upper line to the one in the lower line can be related with the communications apparatus 3 in order. It is also acceptable to perform the relating with the communications apparatus 3 using other rules instead of the above rule.

After deciding the number of communications apparatuses to be assigned to each equipment management apparatus, the number control unit 15 structures a connection relation between the equipment management apparatus 2 and the communications apparatus 3. Then, the number control unit 15 outputs the structured connection relation to the directory server 8. The directory server 8 stores the input connection relation in the directory information base 9. The order of relating (defining the connection relation) the equipment management apparatus 2 to the communications apparatus 3 is based on the order of the operator's inputting the name of Ah the communications apparatus 3 at step 403.

Supposing m=4, n1=20 and n2=20, two communications apparatuses 3 are assigned to the equipment management apparatus 2b based on the expression 4×20/(20+20)=2. Besides, two communications apparatuses 3 are assigned to the equipment management apparatus 2c based on the expression 4×20/(20+20)=2.

Supposing m=4, n1=10 and n2=20, one communications apparatus 3 is assigned to the equipment management apparatus 2b based on the expression 4×10/(10+20)=4/3≈1, and three communications apparatuses 3 are assigned to the equipment management apparatus 2c based on the expression 4×20/(10+20)=8/3≈3.

Now, the operation of the operator of the directory apparatus 4 registering the (m+1)th communications apparatus 3 will be explained. As shown in FIG. 8, the number control unit 15 stores the number “(n1, n2, . . . )” indicating the number of communications apparatuses 3 which the equipment management apparatus 2 can manage, and the number “(m1, m2, . . . )” indicating the number of communications apparatuses 3 which are currently connected with the equipment management apparatuses 2.

When the operator of the directory apparatus 4 wants to add one more communications apparatus 3, the operator inputs the (m+1)th communications apparatus 3 through the operator input/output unit 10. The number control unit 15 calculates the assign number (m1′, m2′, . . . ) of the communications apparatuses 3 to be assigned to each equipment management apparatus 2 based on the steps 402 and 403.

In the case of m1′>m1, the (m+1)th communications apparatus 3 is assigned to the equipment management apparatus. When m1′=m1, instead of assigning the (m+1)th communications apparatus 3 to the equipment management apparatus, m2′ is compared with m2 at step 404.

In this way, the (m+1)th communications apparatus 3 can be related to an appropriate equipment management apparatus 2. If it is needed to add n communications apparatuses, m+n communications apparatuses 3 can be respectively related to appropriate equipment management apparatuses 2 using the same way. Namely, it is possible to relate m+1 through m+n communications apparatuses 3 to appropriate equipment management apparatuses 2.

When it is supposed that m=4, n1=20, and n2=20, information of m1=2 and m2=2 is stored in the number control unit 15. If the (m+1)th (that is 5th) communications apparatus 3 is registered, the new assign number m1′ for the equipment management apparatus 2b is calculated by 5×20/(20+20)=5/2≈3, and the new assign number m2′ for the equipment management apparatus 2c is calculated by 5×20/(20+20)=5/2≈3. As m1′>m1, and m2′>m2, it is possible to assign the (m+1)th communications apparatus 3 to either of the equipment management apparatus 2b or the equipment management apparatus 2c. In this case, since the equipment management apparatus 2b is registered in the upper line of information of the number control unit 15, the (m+1)th communications apparatus 3 is assigned to the equipment management apparatus 2b.

When it is supposed that m=4, n1=10, and n2=20, information of m1=1 and m2=3 is stored in the number control unit 15. If the (m+1)th (that is 5th) communications apparatus 3 is registered, the new assign number m1′ for the equipment management apparatus 2b is calculated by 5×10/(10+20)=5/3≈2, and the new assign number m2′ for the equipment management apparatus 2c is calculated by 5×20/(10+20)=10/3≈3. Then, as m1′>m1, the (m+1)th communications apparatus 3 is assigned to the equipment management apparatus 2b.

The case of there being a communications apparatus which is not assigned to any equipment management apparatus after the assign number calculation, will now be explained. The following condition can be considered in the case of there being a communications apparatus not assigned to any equipment management apparatus.

(A) m>(n1+n2+. . . )

(B) m=<(n1+n2+. . . ) but some communications apparatus is not assigned based on the conclusion of the rounding off calculation.

In (A) case, it is necessary to require the operator to deal with the case. The number control unit 15 of the directory apparatus 4 shows a message of “the number of the communications apparatuses is over the possible assign number” to the operator through the input/output unit 10. Then, the operator will deal with the case based on the message. In (B) case, the equipment management apparatuses 2 registered in the information of the number control unit 15 of the directory apparatus 4 are searched from the upper line to the lower in order to find the equipment management apparatus 2 which meets the condition of m1<n1. Then, the communications apparatus 3 is assigned to the found equipment management apparatus 2 satisfying the condition.

As stated above, the number control unit 15 assigns (defines the connection relation) the communications apparatus 3 depending upon the connection ability of the equipment management apparatus 2, which makes it possible to most effectively utilize the monitor/control ability of the whole equipment management apparatuses 2.

In addition to the features of the network management system Embodiment 1 or Embodiment 2, the network management system according to the present Embodiment 3 has a feature that the number control unit 15 which stores the maximum number of the communications apparatuses 3 to be connected to the equipment management apparatus 2 and the number of the communications apparatuses 3 currently connected to the equipment management apparatus 2, and controls the connection number of the communications apparatuses 3 is provided in the directory apparatus 4.

According to one aspect of the network management system and the network management method of the present Embodiment, as the number control unit is provided, it is possible to define communications apparatuses to be connected with an equipment management apparatus based on faculty of the equipment management apparatuses and the current connection state.

Embodiment 4

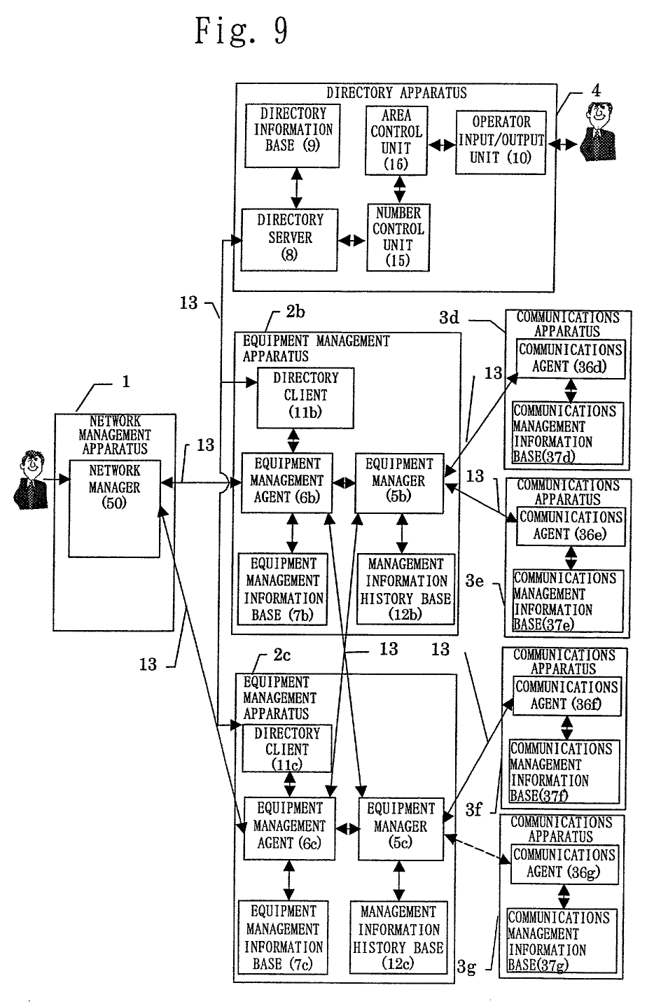

FIG. 9 shows an example of configuration according to Embodiment 4 of the present invention. In FIG. 9, configuration elements represented by the same references used in FIG. 7 indicate the same elements as those of Embodiment 3.

An area control unit 16 compares locations of the equipment management apparatus 2 and the communications apparatus 3, and defines a connection relation between the equipment management apparatus 2 and the communications apparatus 3.

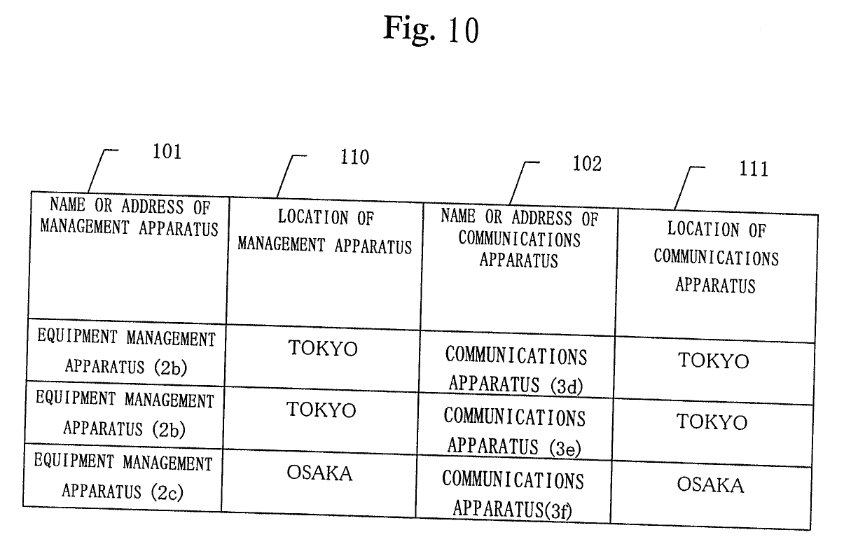

As shown in FIG. 10 as an example, the directory information base 9 stores information of “name or address of the equipment management apparatus” (101), “location of the equipment management apparatus” (110), “name or address of the communications apparatus” (102) and “location of the communications apparatus” (111). Characters, such as TOKYO, or code numbers, such as 03, can be used for showing the “location of the equipment management apparatus” (110) and the “location of the communications apparatus” (111).

Now, the operation will be explained. The operator of the directory apparatus 4 inputs the address and the location of the communications apparatus through the operator input/output unit 10. The operator input/output unit 10 registers the input address and location of the communications apparatus 3 in the directory information base 9.

By using the number control unit 15, the area control unit 16 calculates the number of the communications apparatuses 3 each of which can be assigned to each equipment management apparatus 2.

Then, based on the stored address and location of the communications apparatus in the directory information base 9, the area control unit 16 gives priority to connect the equipment management apparatus 2 and the communications apparatus 3 which belong to the same area, structures a connection relation between the equipment management apparatus 2 and the communications apparatus 3, and outputs the connection relation to the directory server 8 through the number control unit 15. The directory server 8 stores the input connection relation in the directory information base 9.

Thus, as the area control unit 16 is provided in the directory apparatus 4, the locations of the equipment management apparatus 2 and the communications apparatus 3 are compared in order to give priority to connect the equipment management apparatus 2 and the communications apparatus 3 belonging to the same area. Therefore, the equipment management apparatus 2 and the communications apparatus 3 can be most location-wise appropriately allocated.

As stated above, in addition to the features of the network management system of Embodiment 3, the network management system according to the present Embodiment 4 has a feature that the area control unit 16 for comparing the locations of the equipment management apparatus 2 and the communications apparatus 3 and relating the communications apparatus 3 with the equipment management apparatus 2 is provided in the directory apparatus 4.

According to one aspect of the network management system and the network management method of the present Embodiment, the number control unit can define the connection relation more accurately based on area information.

Embodiment 5

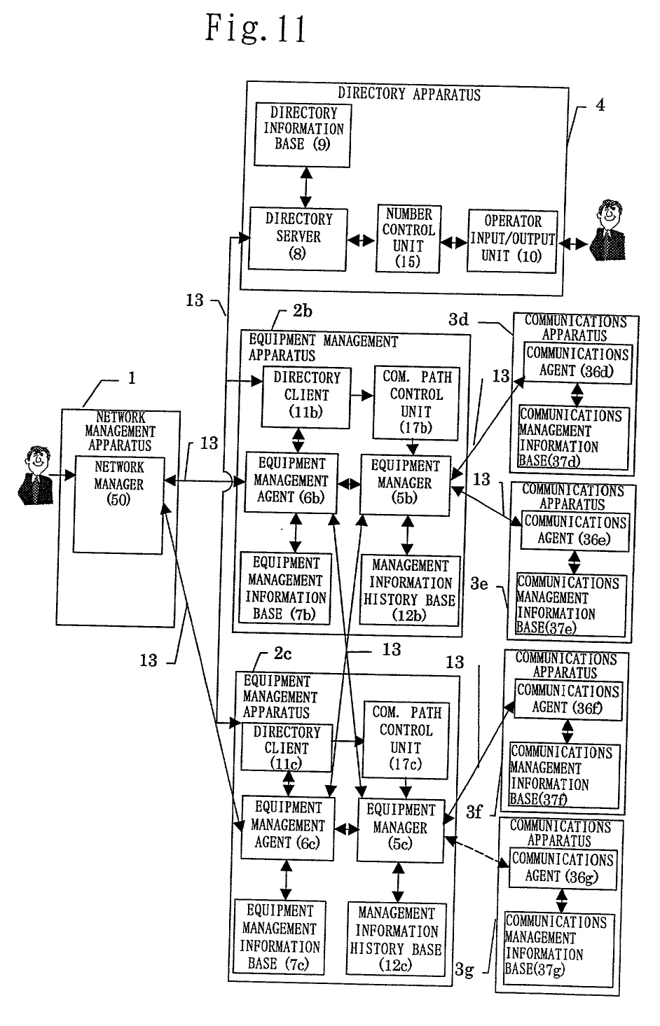

FIG. 11 shows an example of configuration according to Embodiment 5 of the present invention. In FIG. 11, configuration elements represented by the same references used in FIG. 7 indicate the same elements as those of Embodiment 3. A communications path control unit 17 controls the communications path between the equipment management apparatus 2 and the communications apparatus 3. In the example of FIG. 11, a communications path control unit 17b is provided in the equipment management apparatus 2b and a communications path control unit 17c is provided in the equipment management apparatus 2c.

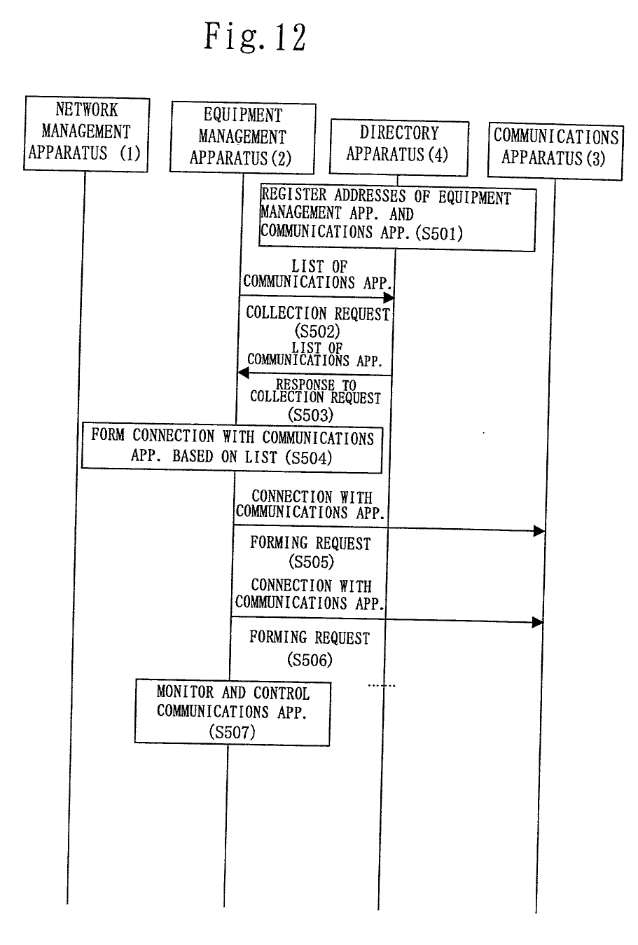

Now, the operation will be explained. FIG. 12 shows an example of operation sequence according to Embodiment 5. With reference to FIG. 12, the operation of the equipment management apparatus 2 forming a communications path to the communications apparatus 3 based on the information of the directory apparatus 4 will be explained.

It is supposed that the directory information base 9 in the directory apparatus 4 stores the connection relation (connection relation information) between the equipment management apparatus 2 and the communications apparatus 3 at step 501.

At the time of starting, the equipment management apparatus 2b, by using the directory client 11b, requests the directory server 8 of the directory apparatus 4 to collect a list (or lists) of the communications apparatuses 3 at step 502. The directory server 8 searches the directory information base 9 and obtains a list of names or addresses of the communications apparatuses (3d, 3e, . . . ) related to the equipment management apparatus 2b. The directory server 8 transmits the obtained list (or lists) to the directory client 11b at step 503.

The directory client 11b of the equipment management apparatus 2b receives the list (or lists) of names or addresses of the communications apparatuses (3d, 3e, . . . ), and transmits the received list to the communications path control unit 17b. Based on this list, the communications path control unit 17b makes the equipment manager 5b form a communications path to the communications apparatuses (3d, 3e, . . . ) at steps 504 through 506. The equipment manager 5b starts monitoring and controlling the communications apparatuses (3d, 3e, . . . ) at step 507.

As stated above, the equipment management apparatus 2 according to the present Embodiment is provided with the communications path control unit 17 which obtains the list of the communications apparatus 3 by using the directory client 11 and directs to monitor and control the communications path forming. Being directed by the communications path control unit 17, the manager 5 forms a communications path to the communications apparatus 3 and starts monitoring and controlling the communications path. Accordingly, it is possible to reduce the operations of the operator of the equipment management apparatus 2.

In addition to the features of the network management system according to Embodiment 3, the network management system of the present Embodiment 5 has a feature that the communications path control unit 17 for controlling the communications path between the equipment management apparatus 2 and the communications apparatus 3 is provided in the equipment management apparatus 2.

According to one aspect of the network management system and the network management method of the present Embodiment, as the communications path control unit is provided, it is possible to establish communications based on connection relations. Therefore, forming and updating communications paths can be effectively performed.

Embodiment 6

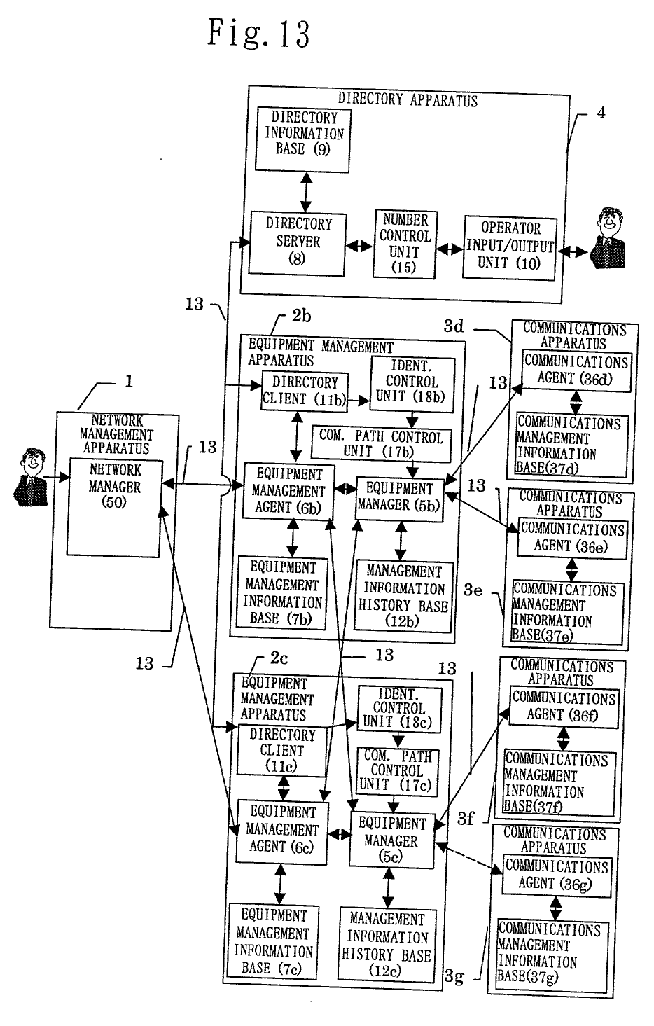

FIG. 13 shows an example of configuration according to Embodiment 6. In FIG. 13, configuration elements represented by the same references used in FIG. 11 indicate the same elements as those of Embodiment 5. An identification control unit 18 obtains identification information of the communications apparatus 3 from the directory apparatus 4.

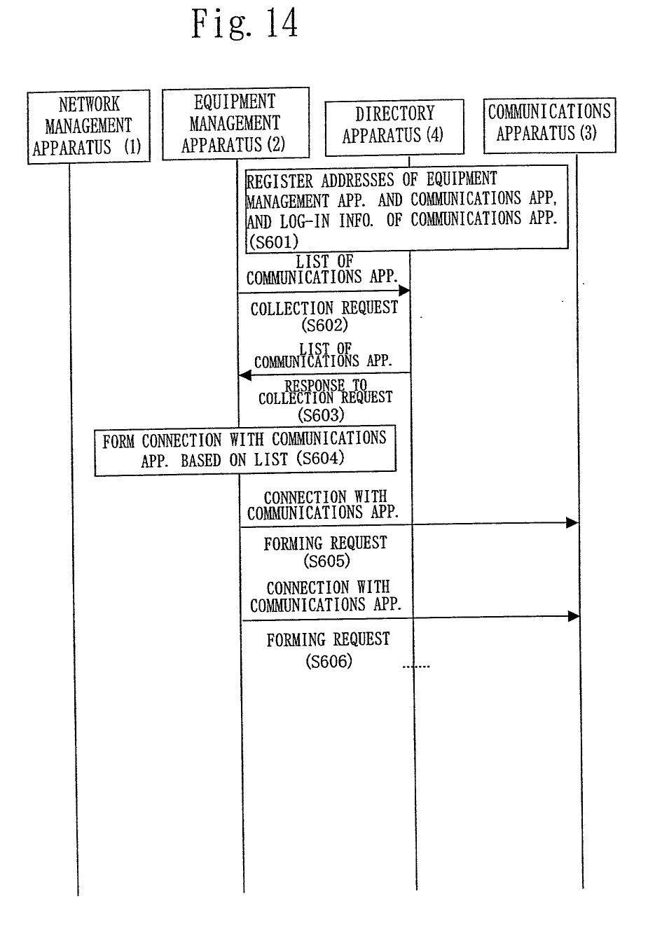

Now, the operation will be explained. FIG. 14 shows an example of operation sequence according to Embodiment 6. With reference to FIG. 14, the operation of the equipment management apparatus 2 forming a communications path to the communications apparatus 3 based on the identification information stored in the directory apparatus 4 will be explained.

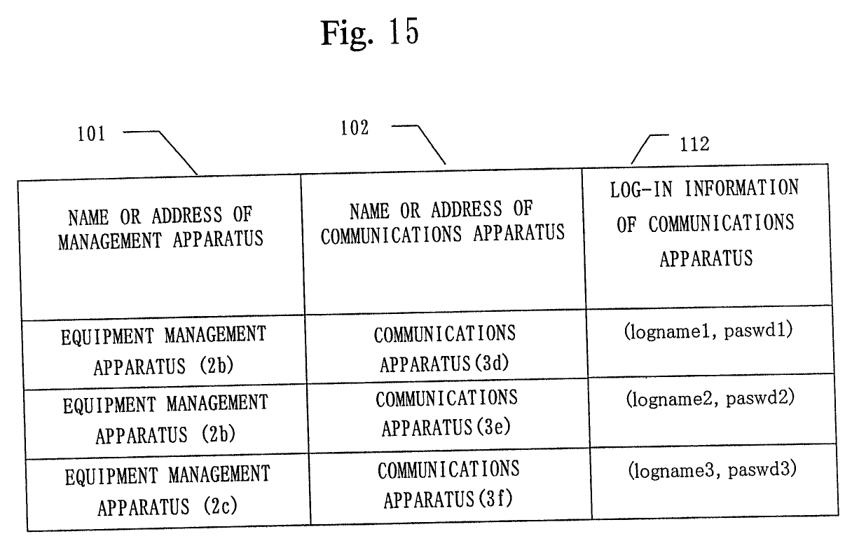

As shown in FIG. 15 as an example, “name or address of the equipment management apparatus” (101), “name or address of the communications apparatus” (102), and “log-in information of the communications apparatus” (112) are stored as information in the directory information base 9 according to Embodiment 6. The log-in information 112 is a combination of a log-in name (character line) and a password (character line) of the communications apparatus 3. It is supposed that the directory information base 9 in the directory apparatus 4 stores the connection relation between the equipment management apparatus 2 and the communications apparatus 3 in advance at step 601.

At the time of starting, the equipment management apparatus 2b, by using the directory client 11b, requests the directory server 8 of the directory apparatus 4 to collect lists of the communications apparatuses 3 at step 602. The directory server 8 searches the directory information base 9 and obtains a list of names (or addresses) and log-in information of the communications apparatuses (3d, 3e, . . . ) related to the equipment management apparatus 2b. The directory server 8 transmits the obtained list to the directory client 11b.

The directory client 11b of the equipment management apparatus 2b receives the list from the directory server 8, and transmits the received list of the name (or address) and log-in information of the communications apparatuses (3d, 3e, . . . ) to the identification control unit 18b. Based on the list, the identification control unit 18b transmits the list of name (or address) and log-in information of the communications apparatuses (3d, 3e, . . . ) to the communications path control unit 17b. The communications path control unit 17b makes the equipment manager 5b form a communications path between the equipment management apparatus 2b and the communications apparatuses (3d, 3e, . . . ). Then, the equipment manager 5b starts monitoring and controlling the communications apparatuses (3d, 3e, . . . ). Therefore, similar to Embodiment 5, it is possible to reduce the operations of the operator of the equipment management apparatus 2.

In addition to the features of the network management system Embodiment 5, the network management system according to the present Embodiment 6 has a feature that the identification control unit 18 for obtaining identification information of communications apparatus 3 from the directory apparatus 4 is provided in the equipment management apparatus 2.

According to one aspect of the network management system and the network management method of the present Embodiment, it is possible to identify a communications apparatus and a network management apparatus based on identification information. Therefore, security of the system can be obtained.

Embodiment 7

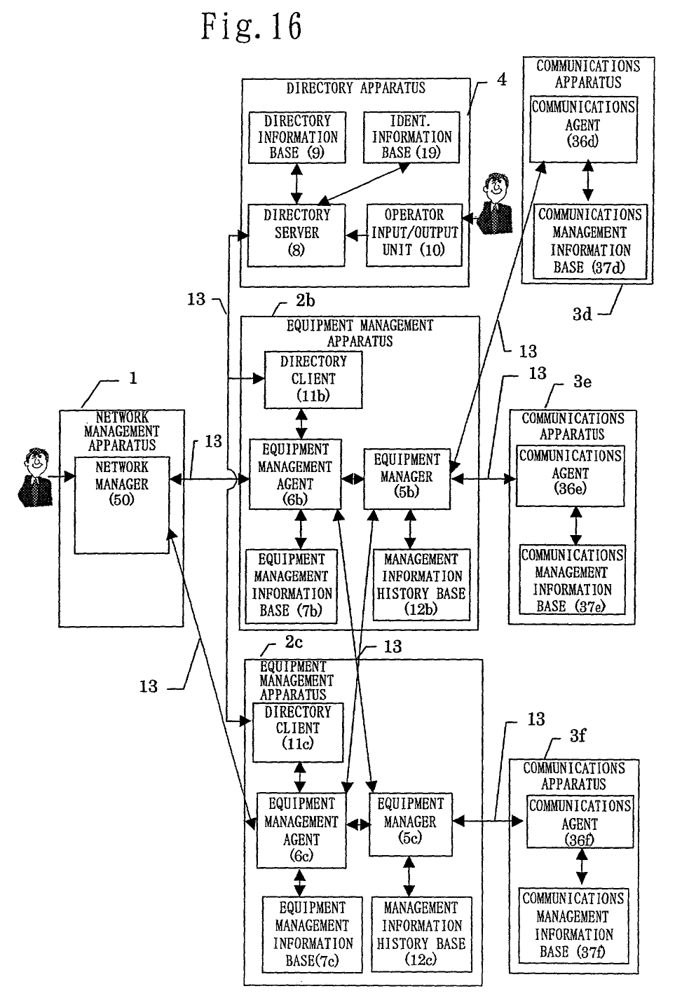

FIG. 16 shows an example of configuration according to Embodiment 7 of the present invention. In FIG. 16, configuration elements represented by the same references used in FIG. 1 indicate the same elements as those of Embodiment 1. An identification information base 19 stores identification information of the network management apparatus 1.

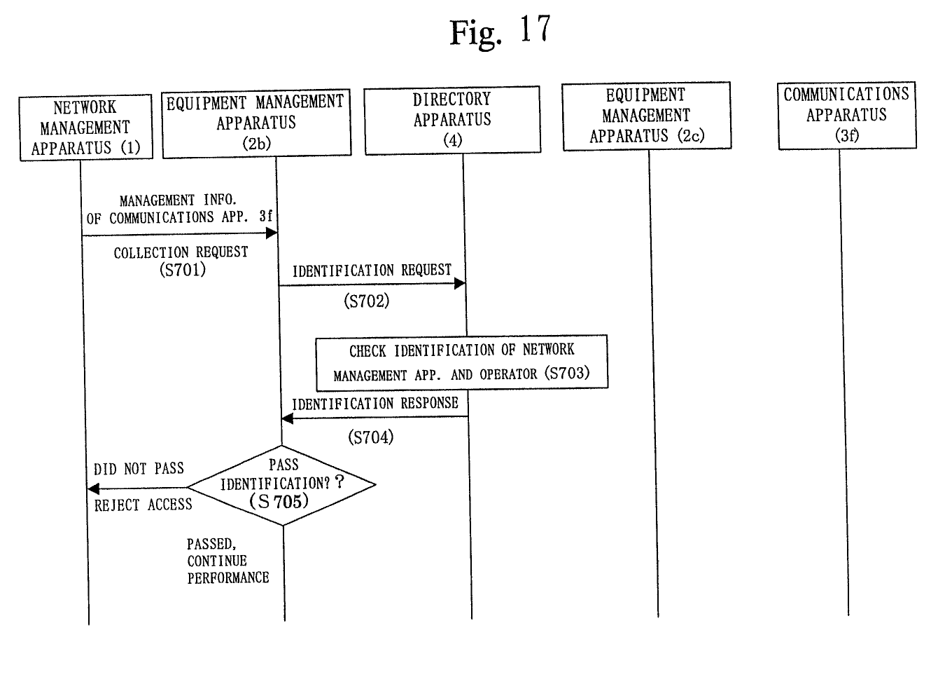

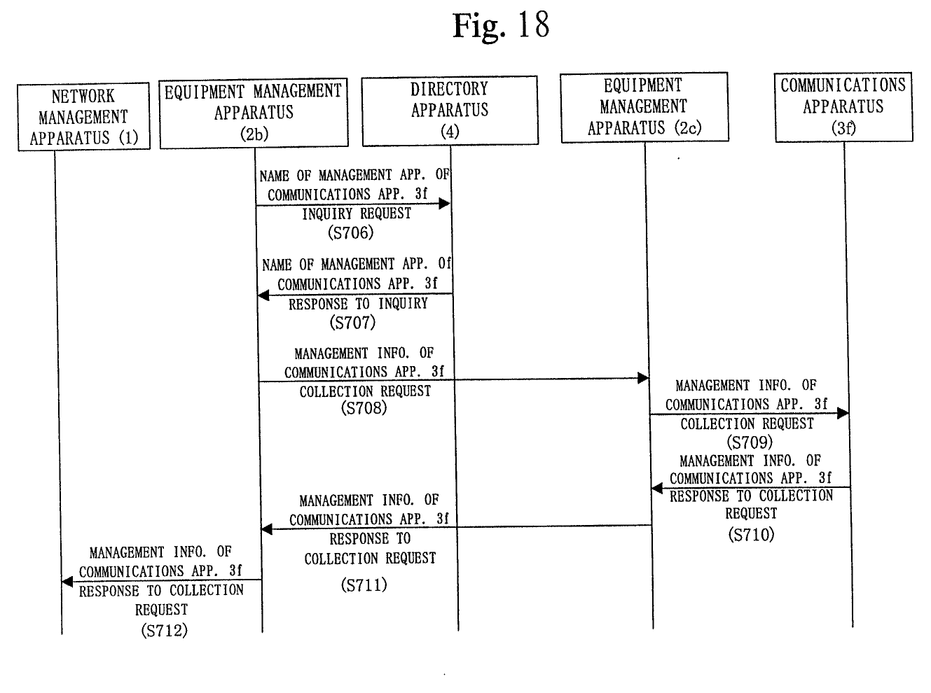

Now, operations will be explained. FIGS. 17 and 18 show examples of operation sequence according to Embodiment 7. With reference to FIGS. 17 and 18, the operation of the equipment management apparatus 2 identifying the network management apparatus 1 will be explained. Then, as an example, the case of the network management apparatus 1 accessing the equipment management apparatus 2b will be described. Requesting to collect management information of the communications apparatus 3f (management information collection request) will be stated as an accessing operation.

The network management apparatus 1 accesses the equipment management apparatus 2b at step 701. Concretely, the network management apparatus 1 transmits a request for collecting management information of the communications apparatus 3f to the equipment management apparatus 2b. The collection request of management information is generated by the network management apparatus 1 as Embodiment 1. The equipment management agent 6b of the equipment management apparatus 2b receives the request for collecting management information of the communications apparatus 3f. The equipment management agent 6b directs the directory client 11b to issue an identification request message based on the received collection request. The directory client 11b issues an identification request message and transmits it to the directory apparatus 4 at step 702. This identification request message includes the address, the operator name, and the password of the network management apparatus 1.

The directory server 8 of the directory apparatus 4 receives the identification request message. Then, the received identification request message is checked against the address, the operator name and the password of the network management apparatus 1 which have been previously stored in the identification information base 19. Then, based on the checking result, the directory server 8 judges whether the contents of the identification request message can pass the identification or not at step 703. The directory server 8 generates an identification response message based on the judged result, and transmits the generated identification response message to the directory client 11b of the equipment management apparatus 2b at step 704.

The directory client 11b judges the received identification response message at step 705. When the identification response message indicates the pass of the identification, the equipment management apparatus 2b accepts operations from the network management apparatus 1. Therefore, the equipment management apparatus 2b executes the processes of the steps 706 through 712 shown in FIG. 18. These processes are the same as those in Embodiment 1. If the identification response message indicates “not passing the identification”, the equipment management apparatus 2b does not accept operations from the network management apparatus 1.

As stated above, since the identification information base 19 is located at the directory apparatus 8 and the directory apparatus 8 identifies the network management apparatus 1 and the operator of the network management apparatus 1 based on the identification information base 19, it is possible to prevent the equipment management apparatus 2 from being wrongly utilized.

In addition to the features of the network management system of Embodiment 1 or Embodiment 2, as stated above, the network management system according to the present Embodiment 7 has a feature that the identification information base 19 for storing identification information of the network management apparatus 1 is provided in the directory apparatus 4.

According to one aspect of the network management system and the network management method of the present Embodiment, it is possible to identify a communications apparatus and a network management apparatus based on identification information. Therefore, security of the system can be obtained.

Embodiment 8

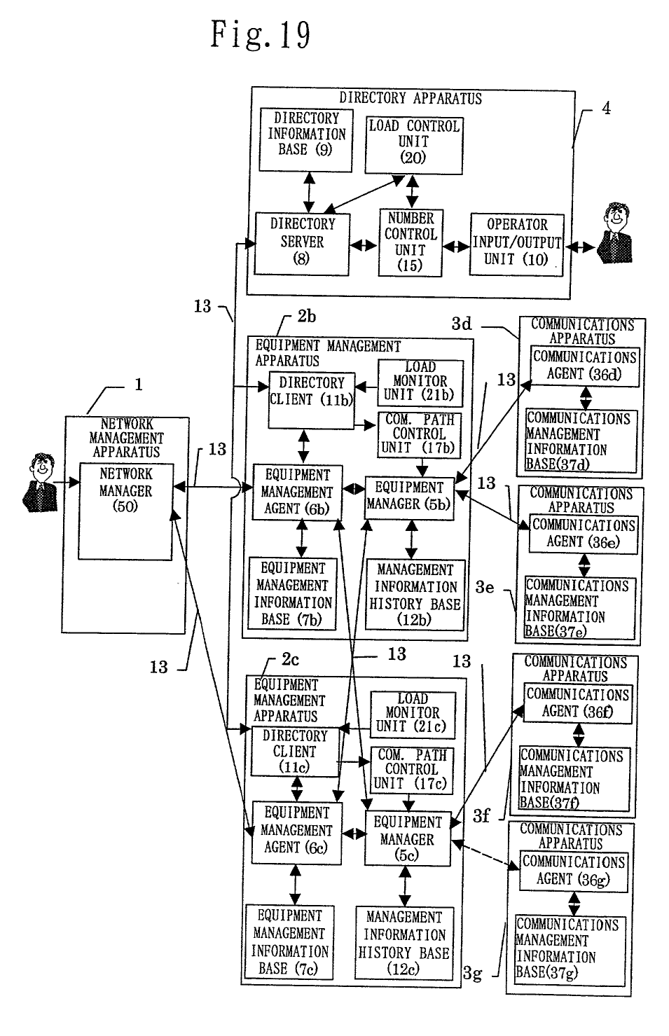

FIG. 19 shows an example of configuration according to Embodiment 8 of the present invention. In FIG. 19, configuration elements represented by the same references used in FIG. 11 indicate the same elements as those of Embodiment 5. A load control unit 20 collects load states of the equipment management apparatuses 2, and appropriately executes a load distribution based on the collected load states. The load control unit 20 collects a load state of each equipment management apparatus 2 and retains the collected load state. The load control unit 20 also retains a threshold corresponding to the load state to be collected. A load monitor unit 21 monitors a load state of the equipment management apparatus 2. In the example of FIG. 19, a load monitor unit 21b is provided in the equipment management apparatus 2b, and a load monitor unit 21c is provided in the equipment management apparatus 2c.

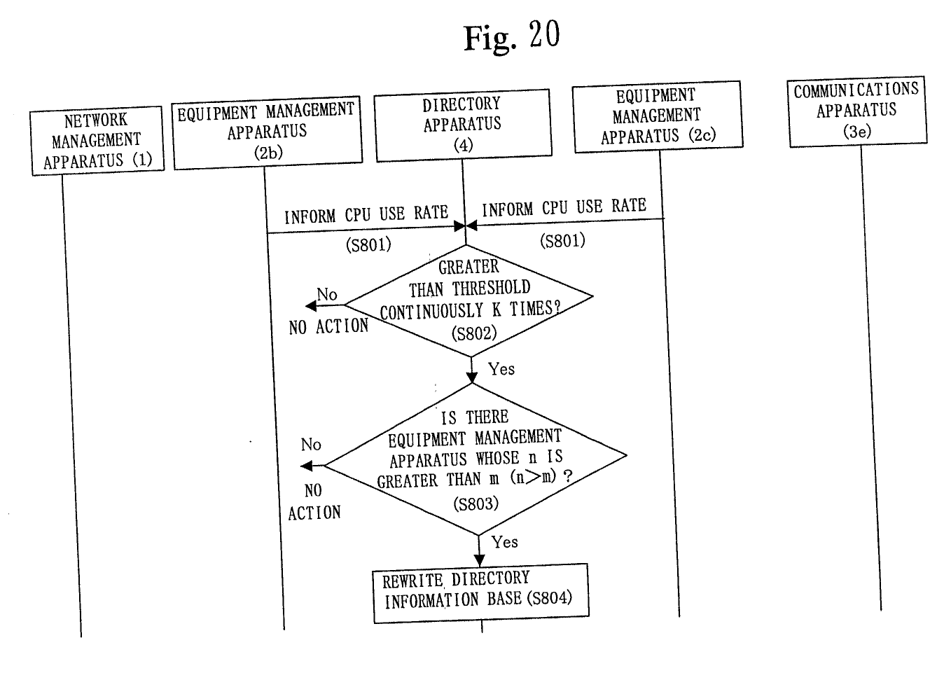

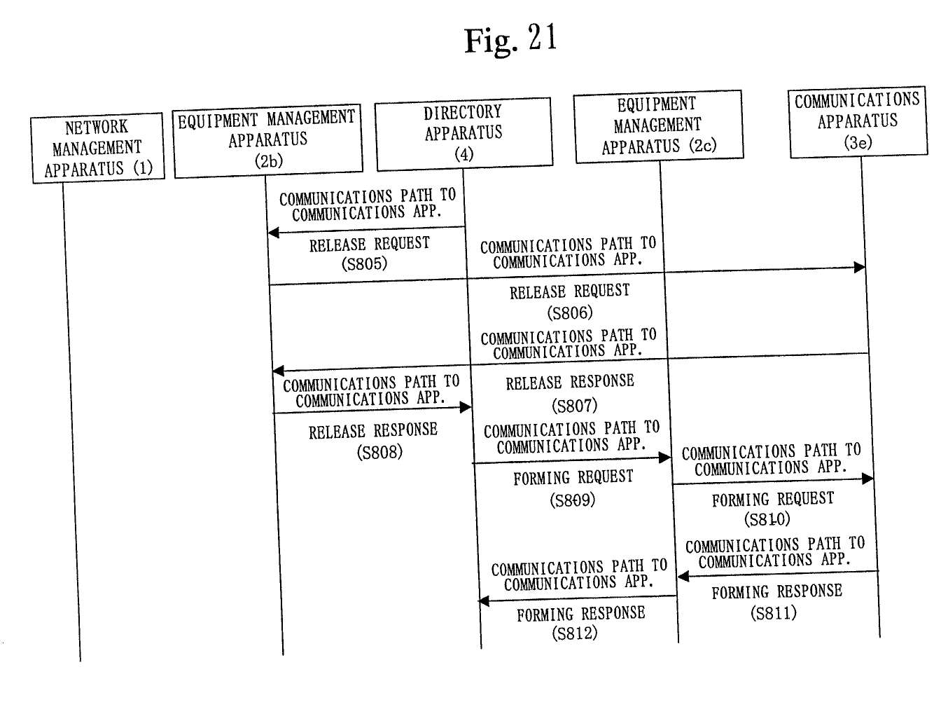

Now, the operation will be explained. FIGS. 20 and 21 show examples of operation sequence according to Embodiment 8. With reference to FIGS. 20 and 21, the operation of the equipment management apparatus 2 informing the directory apparatus 4 of the load state and re-structuring the connection relation between the equipment management apparatus 2 and the communications apparatus 3 will be described.

In the following description, the CPU use rate is used as an example of load state. The load control unit 20 of the directory apparatus 4 retains CPU use rates of previous k cases (k is an optional integer) and a CPU use rate threshold of each equipment management apparatus 2.

The load monitor unit 21b of the equipment management apparatus 2b periodically (ex. every one minute) measures the CPU use rate of the equipment management apparatus 2b, and transmits the measured CPU use rate to the directory server 8 of directory apparatus 4 via the directory client 11b at step 801. The same operations are executed at the equipment management apparatus 2C or other equipment management apparatus.

The directory server 8 outputs the received CPU use rate of each equipment management apparatus (2b, 2c, . . . ) to the load control unit 20. The load control unit 20 analyzes the input CPU use rate at step 802. After the analyzing, if the CPU use rate of the equipment management apparatus 2 continuously keeps values over the threshold k times (k is an optional integer), the load control unit 20 accesses the number control unit 15 in order to direct the number control unit 15 to inquire an address (or addresses) of equipment management apparatus 2 whose maximum number (n) of communications apparatus to be connected with the equipment management apparatus 2 is greater than the number (m) of communications apparatuses currently connected. The number control unit 15 inquires an address (or addresses) of equipment management apparatus 2 whose maximum number (n) of communications apparatuses to be connected is greater than the number (m) of communications apparatuses currently connected (n>m). Then, the inquiring result is transmitted to the load control unit 20 at step 803.

If there is no equipment management apparatus 2 whose n is greater than m (n>m), this operation is finished and no action is performed.

When there is an equipment management apparatus 2 whose n is greater than m (n>m), the load control unit 20 disconnects one of communications apparatuses 3 (ex. communications apparatus 3e) related to the equipment management apparatus 2 (ex. equipment management apparatus 2b), and structures a new connection relation for the equipment management apparatus 2. Then, the new structured connection relation is registered in the directory information base 9 through the directory server 8 at step 804.

The load control unit 20 transmits a request for releasing the communications path to the communications apparatus 3e, to the directory client 11b of the equipment management apparatus 2b via the directory server 8 at step 805. The directory client 11b directs the communications path control unit 17b to release the communications path to the communications apparatus 3e. The communications path control unit 17b transmits this direction to the equipment manager 5b. The equipment manager 5b transmits the request for releasing the communications path between the equipment management apparatus 2b and the communications apparatus 3e, to the equipment management apparatus 2b and to the communications apparatus 3e, at step 806.

The communications apparatus 3e receives the request for releasing the communications path between the equipment management apparatus 2b and the communications apparatus 3e from the equipment manager 5b, and releases the communications path based on the received release request. Then, the communications apparatus 3e transmits a release response telling that the communications path has been released, to the equipment management apparatus 2b, at step 807. (release response) The directory client 11b receives the release response from the communications apparatus 3e and transmits the release response to the directory server 8 at step 808. The directory server 8 informs the load control unit 20 that the communications path between the equipment management apparatus 2b and the communications apparatus 3e has been released.

Next, the load control unit 20 transmits a request for forming a communications path to the communications apparatus 3e, to the directory client 11c of the equipment management apparatus 2c via the directory server 8 at step 809. The directory client 11c directs the communications control unit 17c to form a communications path between the equipment management apparatus 2c and the communications apparatus 3e. The communications control unit 17c transmits this direction to the equipment manager 5c. The equipment manager 5c transmits the request for forming a communications path between the equipment management apparatus 2c and the communications apparatus 3e, to the communications apparatus 3e at step 810.

The communications apparatus 3e receives the request for forming a communications path between the equipment management apparatus 2b and the communications apparatus 3e from the equipment manager 5c and forms the communications path based on the received forming request. Then, the communications apparatus 3e informs the equipment management apparatus 2c that the communications path has been formed at step 811. After forming the communications path, the directory client 11c transmits a forming response telling that the communications path has been formed, to the directory server 8 at step 812. The directory server 8 informs the load control unit 20 that the communications path between the equipment management apparatus 2c and the communications apparatus 3e has been formed.

Thus, by dint of providing the load control unit 20 at the directory apparatus 8 and the load monitor unit 21 at the equipment management apparatus 2, it is possible for the load control unit 20 to comprehend a load of each equipment management apparatus 2 by using the load monitor unit 21, and to dynamically structure a connection relation between the equipment management apparatus 2 and the communications apparatus 3 in order not to incline the load (that is in order to keep the load uniform). Accordingly, the monitoring and controlling can be effectively realized at high speed in the network management system according to the present Embodiment.

In addition to the features of the network management system according to Embodiment 5, the network management system of the present Embodiment 8 has a feature that the load control unit 20 for collecting loads of the equipment management apparatuses 2 and executing an appropriate load distribution is provided in the directory apparatus 4, and the load monitor unit 21 for monitoring the CPU use rate of the equipment management apparatus 2 is provided in the equipment management apparatus 2.

According to one aspect of the network management system and the network management method of the present Embodiment, as the load monitor unit is provided, it is possible to define a connection relation based on load information of the equipment management apparatus. Accordingly, the system can be effectively managed.

Embodiment 9

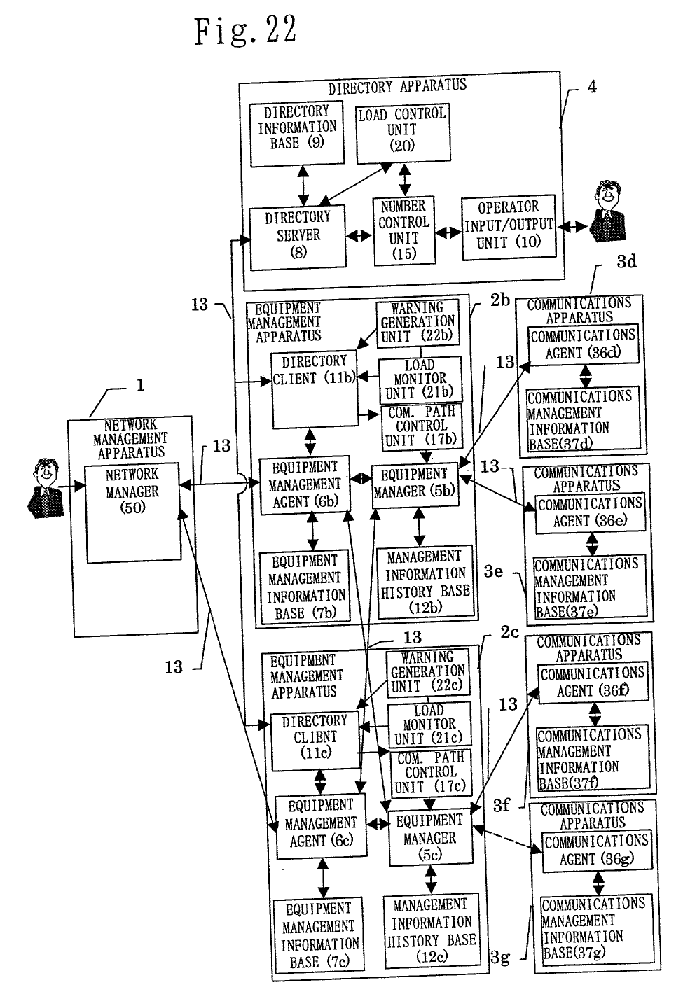

FIG. 22 shows an example of configuration according to Embodiment 9. In FIG. 22, configuration elements represented by the same references used in FIG. 19 indicate the same elements as those of Embodiment 8. A warning generation unit 22 monitors the load state of the equipment management apparatus 2 and generates a warning in the case of predefined conditions being fulfilled. A warning generation unit 22b is provided in the equipment management apparatus 2b and a warning generation unit 22c is provided in the equipment management apparatus 2c.

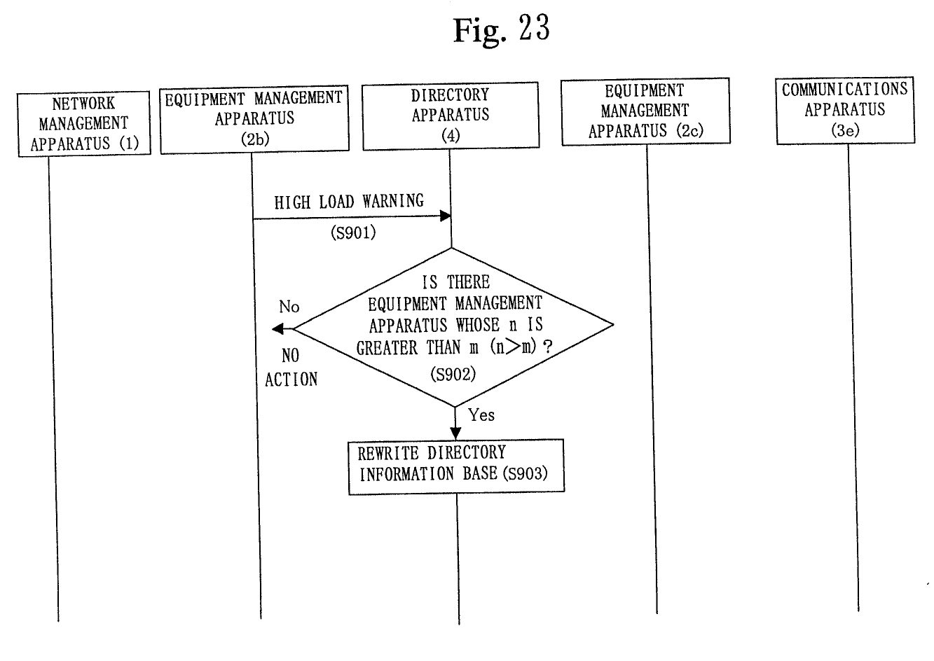

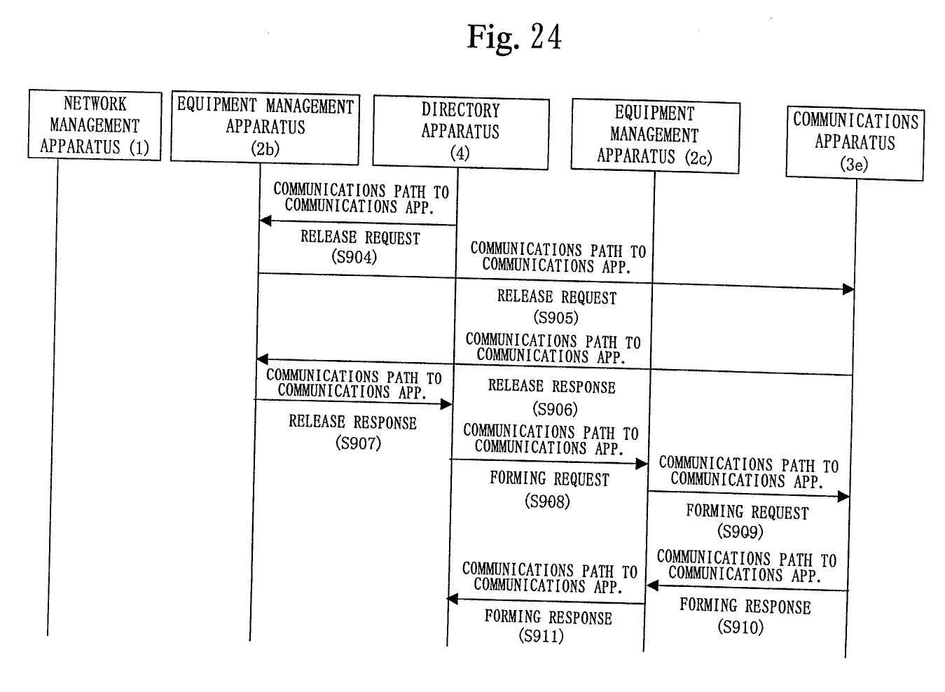

Now, the operation will be explained. FIGS. 23 and 24 show examples of operation sequence according to Embodiment 9. With reference to FIGS. 23 and 24, operations of generating a high load warning by the equipment management apparatus 2b, and switching the connection relation between the equipment management apparatus 2b and the communications apparatus 3e to the connection relation between the equipment management apparatus 2c and the communications apparatus 3e will be described.

The load monitor unit 21b of the equipment management apparatus 2b periodically (ex. every one minute) measures the CPU use rate of the equipment management apparatus 2b, and notifies the warning generation unit 22b of the measured CPU use rate. The same operation is executed at other equipment management apparatus such as the equipment management apparatus 2C.

The warning generation unit (22b 22c, . . . ) retains CPU use rates of previous j cases of each equipment management apparatus (2b, 2c, . . . ). If the CPU use rate of the equipment management apparatus (2b, 2c, . . . ) continuously keeps values over the threshold k times (k is an optional integer), the warning generation unit 22 (one of the warning generation unit 22b, or 22c, . . . ) transmits a high load warning to the directory server 8 via the directory client (11b, 11c, . . . )at step 901.

Receiving the high load warning, the directory server 8 accesses the number control unit 15 in order to direct the number control unit 15 to inquire an address (or addresses) of equipment management apparatus 2 whose maximum number (n) of communications apparatuses to be connected with the equipment management apparatus 2 is greater than the number (m) of communications apparatuses currently connected. The number control unit 15 inquires an address (or addresses) of equipment management apparatus 2 whose maximum number (n) of communications apparatuses to be connected is greater than the number (m) of communications apparatuses currently connected (n>m). Then, the inquiring result is transmitted to the directory server 8 at step 902.

If there is no equipment management apparatus 2 whose n is greater than m (n>m), this operation is finished and no action is performed.

When there is an equipment management apparatus 2 whose n is greater than m (n>m), the load control unit 20 disconnects one of communications apparatuses 3 (ex. the communications apparatus 3e) related to the equipment management apparatus 2 (ex. the equipment management apparatus 2b), and structures a new connection relation for the equipment management apparatus 2. Then, the new structured connection relation is registered in the directory information base 9 through the directory server 8 at step 903.

The load control unit 20 transmits a request for releasing the communications path to the communications apparatus 3e, to the directory client 11b of the equipment management apparatus 2b via the directory server 8 at step 904. The directory client 11b directs the communications path control unit 17b to release the communications path between the equipment management apparatus 2b and the communications apparatus 3e. The communications path control unit 17b transmits this direction to the equipment manager 5b. The equipment manager 5b transmits the request for releasing the communications path between the equipment management apparatus 2b and the communications apparatus 3e to the communications apparatus 3e at step 905.

The communications apparatus 3e receives the request for releasing the communications path between the equipment management apparatus 2b and the communications apparatus 3e from the equipment manager 5b, and releases the communications path based on the received release request. Then, the communications apparatus 3e transmits a release response telling that the communications path has been released, to the equipment management apparatus 2b at step 906. (release response) The directory client 11b receives the release response from the communications apparatus 3e and transmits the release response to the directory server 8 at step 907. The directory server 8 informs the load control unit 20 that the communications path between the equipment management apparatus 2b and the communications apparatus 3e has been released.

Next, the load control unit 20 transmits a request for forming a communications path to the communications apparatus 3e, to the directory client 11c of the equipment management apparatus 2c via the directory server 8 at step 908. The communications apparatus 3e receives the request for forming a communications path between the equipment management apparatus 2b and the communications apparatus 3e from the equipment manager 5c and forms the communications path based on the received forming request. Then, the communications apparatus 3e informs the equipment management apparatus 2c that the communications path has been formed at step 910. The directory client 11c directs the communications control unit 17c to form a communications path between the equipment management apparatus 2c and the communications apparatus 3e. The communications control unit 17c transmits this direction to the equipment manager 5c.

The equipment manager 5c transmits the request for forming a communications path between the equipment management apparatus 2c and the communications apparatus 3e, to the communications apparatus 3e at step 909. After forming the communications path, the directory client 11c transmits a forming response telling that the communications path has been formed, to the directory server 8 at step 911. The directory server 8 informs the load control unit 20 that the communications path between the equipment management apparatus 2c and the communications apparatus 3e has been formed.

According to the present Embodiment 9, as stated above, the load control unit 20 is provided in the directory apparatus 4 and the load monitor unit 21 and the warning generation unit 22 are provided in the equipment management apparatus 2. In the case of the equipment management apparatus being highly loaded, the load control unit 20 can dynamically structure the connection relation between the equipment management apparatus and the communications apparatus in order not to incline the load (that is in order to keep the load uniform) by using the load monitor unit 21 and the warning generation unit 22. Thus, the monitoring and controlling can be effectively realized at high speed in the network management system according to the present Embodiment.

In addition to the features of the network management system according to Embodiment 8, the network management system of the present Embodiment 9 has a feature that the warning generation unit 22 for monitoring the load state of the equipment management apparatus 2 and generating a warning in the case of predefined conditions being fulfilled is provided in the equipment management apparatus 2.

According to one aspect of the network management system and the network management method of the present Embodiment, as the warning generation unit is provide, it is possible to notify the outside of the internal status of the equipment management apparatus.

Having thus described several particular embodiments of the invention, various alterations, modifications, and improvements will readily occur to those skilled in the art. Such alterations, modifications, and improvements are intended to be part of this disclosure, and are intended to be within the spirit and scope of the invention. Accordingly, the foregoing description is by way of example only, and not intended to be limiting. The invention is limited only as defined in the following claims and the equivalents thereto.

What is claimed is:

1. A network management system comprising:
a plurality of communications apparatuses for performing communications through a network;
an equipment management apparatus, connected to at least one of the plurality of communications apparatuses through the network, for monitoring and controlling the at least one of the plurality of communications apparatuses; and
a directory apparatus for managing connection relations between the plurality of communications apparatuses and the equipment management apparatus,
wherein the equipment management apparatus includes a directory client for transmitting an obtaining request for obtaining a connection relation and receiving the connection relation corresponding to the obtaining request, and
the directory apparatus includes a directory information base for storing the connection relations and a directory server for receiving the obtaining request from the directory client, searching the directory information base in order to detect the connection relation corresponding to the obtaining request, and transmitting the connection relation having been detected to the directory client.

2. The network management system of claim 1 further comprising:
a network management apparatus for managing the plurality of communications apparatuses and the equipment management apparatus and transmitting the obtaining request,
wherein the directory client receives the obtaining request from the network management apparatus, transmits the obtaining request to the directory server, receives the connection relation corresponding to the obtaining request from the directory server, and transmits the connection relation having been received to the network management apparatus.

3. The network management system of claim 1,
wherein the equipment management apparatus includes a plurality of equipment management apparatuses,
the directory information base stores connection relations between the plurality of equipment management apparatuses and the plurality of communications apparatuses, and
the directory client included in one of the plurality of equipment management apparatuses transmits the obtaining request, to the directory server, for obtaining a connection relation between another of the plurality of equipment management apparatuses and at least one of the plurality of communications apparatuses connected to the another of the plurality of equipment management apparatuses, and receives the connection relation corresponding to the obtaining request from the directory server.

4. The network management system of claim 1, wherein the directory apparatus includes an input unit for receiving an input relating to the connection relation, and the directory server inputs the connection relation received through the input unit and stores the connection relation in the directory information base.

5. The network management system of claim 1,
wherein the equipment management apparatus further comprises a relation register unit for inquiring a connection relation between the equipment management apparatus and the plurality of communications apparatuses, and transmitting an inquired connection relation to the directory server, and
the directory server receives the inquired connection relation from the relation register unit and stores a received connection relation in the directory information base.

6. The network management system of claim 4, wherein the directory apparatus further includes
a communications apparatus information table for storing a maximum number of the plurality of communications apparatuses which can be connected with the equipment management apparatus and a number of the plurality of communications apparatuses which are currently connected with the equipment management apparatus, and
a number control unit for defining the plurality of communications apparatuses to be connected with the equipment management apparatus, based on the maximum number of the plurality of communications apparatuses which can be connected with the equipment management apparatus and the number of the plurality of communications apparatuses which are currently connected with the equipment management apparatus stored in the communications apparatus information table.

7. The network management system of claim 6,
wherein the directory information base further stores locations of the plurality of communications apparatuses, and
the directory apparatus further includes an area control unit for defining the plurality of communications apparatuses to be connected with the equipment management apparatus, based on the maximum number of the plurality of communications apparatuses which can be connected with the equipment management apparatus and the number of the plurality of communications apparatuses which are currently connected with the equipment management apparatus stored in the communications apparatus information table, and the locations stored in the directory information base.

8. The network management system of claim 4,
wherein the equipment management apparatus further includes a communications path control unit for inputting the connection relation received by the directory client and transmitting a request for establishing communications based on an input connection relation, to at least one of the plurality of communications apparatuses, and
each of the plurality of communications apparatuses further includes a communications agent for receiving the request for establishing communications from the communications path control unit, and establishing the communications with the equipment management apparatus based on a received request.

9. The network management system of claim 4,
wherein the directory information base further stores identification information, to be corresponding to each of the plurality of communications apparatuses, for identifying the each of the plurality of communications apparatuses,
the directory server detects identification information corresponding to at least one of the plurality of communications apparatuses optionally selected, in the directory information base, and
the equipment management apparatus further includes an identification control unit for transmitting a request for obtaining the identification information corresponding to the at least one of the plurality of communications apparatuses optionally selected to the directory server, receiving the identification information from the directory server, and identifying the at least one of the plurality of communications apparatuses optionally selected based on a received identification information.

10. The network management system of claim 2,
wherein the directory apparatus further includes an identification information base for storing identification information for identifying the network management apparatus,
the directory server detects the identification information corresponding to the network management apparatus from the identification information base, and
the directory client receives the obtaining request from the network management apparatus, transmits a request for obtaining the identification information corresponding to the network management apparatus to the directory server, receives the identification information from the directory server, and identifies the network management apparatus based on the identification information having been received.

11. The network management system of claim 3,
wherein each of the plurality of equipment management apparatuses includes a load monitor unit for monitoring a load state of the each of the plurality of equipment management apparatuses, and
the directory apparatus further includes a load control unit for collecting load states from the load monitor unit included in the each of the plurality of equipment management apparatuses and managing the plurality of communications apparatuses connected to the plurality of equipment management apparatuses, based on the load states having been collected.

12. The network management system of claim 11,
wherein each of the plurality of equipment management apparatuses further includes a warning generation unit for generating a warning when the load state monitored by the load monitor unit is over a predefined threshold.

13. The network management system of claim 3, wherein the directory apparatus includes an input unit for receiving an input relating to the connection relation, and the directory server inputs the connection relation received through the input unit and stores the connection relation in the directory information base.

14. The network management system of claim 13, wherein the directory apparatus further includes
a communications apparatus information table for storing a maximum number of the plurality of communications apparatuses which can be connected with one of the plurality of equipment management apparatuses and a number of the plurality of communications apparatuses which are currently connected with the one of the plurality of equipment management apparatuses, and
a number control unit for defining the plurality of communications apparatuses to be connected with the one of the plurality of equipment management apparatuses, based on the maximum number of the plurality of communications apparatuses which can be connected with the one of the plurality of equipment management apparatuses and the number of the plurality of communications apparatuses which are currently connected with the one of the plurality of equipment management apparatuses stored in the communications apparatus information table.

15. The network management system of claim 13,
wherein each of the plurality of equipment management apparatuses further includes a communications path control unit for inputting the connection relation received by the directory client and transmitting a request for establishing communications based on an input connection relation, to at least one of the plurality of communications apparatuses, and
each of the plurality of communications apparatuses further includes a communications agent for receiving the request for establishing communications from the communications path control unit, and establishing the communications with one of the plurality of equipment management apparatuses based on a received request.

16. The network management system of claim 3,
wherein each of the plurality of equipment management apparatuses further comprises a relation register unit for inquiring a connection relation between the plurality of equipment management apparatuses and the plurality of communications apparatuses, and transmitting an inquired connection relation to the directory server, and
the directory server receives the inquired connection relation from the relation register unit and stores a received connection relation in the directory information base.

17. The network management system of claim 1,
wherein the equipment management apparatus includes a load monitor unit for monitoring a load state of the equipment management apparatus, and
the directory apparatus further includes a load control unit for obtaining the load state from the load monitor unit included in the equipment management apparatus and managing the plurality of communications apparatuses connected to the equipment management apparatus, based on an obtained load state.

18. A directory apparatus comprising:
a directory information base for storing connection relations defining communications paths between a plurality of communications apparatuses and a plurality of equipment management apparatuses which monitor and control the plurality of communications apparatuses; and
a directory server for receiving an obtaining request for obtaining a connection relation, searching the directory information base in order to detect the connection relation corresponding to a received obtaining request, and transmitting a detected connection relation.

19. The directory apparatus of claim 18 further comprising an input unit for inputting the connection relation, wherein the directory server inputs the connection relation received through the input unit and stores the connection relation in the directory information base.

20. A network management method of a network system composed of a plurality of communications apparatuses, and a plurality of equipment management apparatuses, connected to the plurality of communications apparatuses through a network, for monitoring and controlling the plurality of communications apparatuses, the network management method comprising:
storing connection relations for defining communications paths connecting the plurality of communications apparatuses and the plurality of equipment management apparatuses in a directory information base;
receiving an obtaining request for obtaining a connection relation;
detecting the connection relation corresponding to a received obtaining request by way of searching the directory information base; and
transmitting a detected connection relation.
